(19) United States
(12) Patent Application Publication
(10) Pub. No.: US 2025/0240601 A1
(43) Pub. Date: Jul. 24, 2025

(54) ISSUING EMERGENCY ALERT(S) FOR DETECTED LIFE-THREATENING EVENTS INVOLVING POWER SYSTEMS

(71) Applicant: Safeguard Equipment, Inc., Post Falls, ID (US)

(72) Inventors: John Wayne Thompson, Coeur d' Alene, ID (US); Louis Graham, Sandpoint, ID (US); Samuel Charles Schaffer, Coeur d' Alene, ID (US); Tucker Lee Shannon, Spokane, WA (US)

(21) Appl. No.: 19/176,573

(22) Filed: Apr. 11, 2025

Related U.S. Application Data
(63) Continuation of application No. 18/217,202, filed on Jun. 30, 2023.
Application No. 18/217,202 is a continuation of application No. 18/140,352, filed on Apr. 27, 2023.
(60) Provisional application No. 63/336,620, filed on Apr. 29, 2022.
(60) Provisional application No. 63/422,810, filed on Nov. 4, 2022.

(51) Int. Cl. H04W 4/02; H04W 4/38; H04W 4/90

(52) U.S. Cl. CPC H04W 4/023; H04W 4/38; H04W 4/90

(57) ABSTRACT

A method includes receiving first data indicative of an emergency alert being issued by a first device worn by a user, determining a first responder, and a second responder associated with the user, receiving, via a second device of the first responder, a first location of the first responder, receiving, via a third device of the second responder, a second location of the second responder, determining that the first location is more proximate to the user than the second location, generating second data associated with the emergency alert, where the second data indicating at least a third location of the user, an identifier of the user, or a type of the emergency alert, and sending the second data to the second device.

### CROSS-REFERENCE TO RELATED APPLICATIONS

This application is a continuation of and claims priority to U.S. Utility patent application Ser. No. 18/217,202, filed Jun. 30, 2023, which is a continuation of and claims priority to U.S. Utility patent application Ser. No. 18/140,352, filed Apr. 27, 2023, which claims priority to U.S. Provisional Patent Application No. 63/336,620, filed Apr. 29, 2022, entitled “Issuing Emergency Alert(s) for Detected Life-Threatening Events Involving Power Systems,” and U.S. Provisional Patent Application No. 63/422,810, filed Nov. 4, 2022, entitled “Personal Wearable Arc Flash Detection and Emergency Notification Device,” the entirety of which are herein incorporated by reference.

### BACKGROUND

Electrical power has been in high-demand worldwide. In some cases, workers are setting up new power systems to provide power to places not yet connected. In other cases, workers are updating or enhancing established systems, or repairing and/or rebuilding power systems damaged by natural causes and/or accidental events. Yet, still in other cases, workers may be tasked with removing a power system from an area where power is no longer needed or desired. Regardless of the task, the workers are constantly engaging in activities surrounding power systems that have inherent dangers via which the workers could be harmed. Unfortunately, despite the safety regulations and practices designed to prevent accidents in the energy industry, workers are still injured and/or killed. Additionally, response times and procedures when responding to the workers are inadequate.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a first perspective view of an example safety device, according to an example of the present disclosure.

FIG. 2 illustrates a second perspective view of the safety device of FIG. 1, according to an example of the present disclosure.

FIG. 3A illustrates a first side view of the safety device of FIG. 1, according to an example of the present disclosure.

FIG. 3B illustrates a second side view of the safety device of FIG. 1, according to an example of the present disclosure.

FIG. 4A illustrates a third side view of the safety device of FIG. 1, according to an example of the present disclosure.

FIG. 4B illustrates a fourth side view of the safety device of FIG. 1, according to an example of the present disclosure.

FIG. 5A illustrates a fifth side view of the safety device of FIG. 1, according to an example of the present disclosure.

FIG. 5B illustrates a sixth side view of the safety device of FIG. 1, according to an example of the present disclosure.

FIG. 6A illustrates a first view of a printed circuit board (PCB) of the safety device of FIG. 1, according to an example of the present disclosure.

FIG. 6B illustrates a second view of the PCB of FIG. 6A, according to an example of the present disclosure.

FIG. 7 illustrates an example of a user wearing the safety device of FIG. 1, according to an example of the present disclosure.

FIG. 8 illustrates a system architecture for implementing processes described herein, according to an example of the present disclosure.

FIG. 9 illustrates select components of the safety device of FIG. 1, according to an example of the present disclosure.

FIG. 10 illustrates select components of a remote system in communication with the safety device of FIG. 1, according to an example of the present disclosure.

FIG. 11 illustrates select components of a user device in communication with the safety device of FIG. 1, according to an example of the present disclosure.

FIG. 12 illustrates select functional components of a responder device in communication with the safety device of FIG. 1, according to an example of the present disclosure.

FIG. 13 illustrates an example signal diagram for communicating an emergency alert from the safety device of FIG. 1, according to an example of the present disclosure.

FIG. 14 illustrates an example process for determining an occurrence of a life-threatening event and issuing an emergency alert, according to an example of the present disclosure.

FIG. 15 illustrates an example process for determining an occurrence of a life-threatening event and issuing an emergency alert, according to an example of the present disclosure.

FIG. 16 illustrates an example process for issuing an emergency alert, according to an example of the present disclosure.

FIG. 17 illustrates an example process for determining whether responders are responding to an emergency alert, according to an example of the present disclosure.

FIG. 18 illustrates an example process performed by a user device for causing an emergency alert to be issued, according to an example of the present disclosure.

FIG. 19 illustrates example displays associated with presenting emergency alerts, according to an example of the present disclosure.

FIG. 20 illustrates example displays associated with presenting emergency alerts, according to an example of the present disclosure.

FIG. 21 illustrates a continuation of the example displays from FIG. 20 associated with presenting emergency alerts, according to an example of the present disclosure.

FIG. 22 illustrates example displays associated with viewing emergency alerts, according to an example of the present disclosure.

FIG. 23 illustrates an example display associated with configuring the safety device of FIG. 1 for detecting and issuing emergency alerts, according to an example of the present disclosure.

FIGS. 24A-24C illustrate an example display associated with determining setting(s) of the safety device of FIG. 1, using a user device, according to an example of the present disclosure.

### DETAILED DESCRIPTION

This application is directed, at least in part, to systems and methods that autonomously detect and/or respond to potential life-threatening events experienced by users (e.g., workers, linemen, electricians, disaster relief personnel etc.) interacting with power systems. In an embodiment, the users may wear a safety device that includes sensors for autonomously detecting the life-threatening events. The sensor(s) may measure arc-flashes, electric fields, magnetic fields, and/or acceleration as a way to detect if one or more life-threatening event(s) were experienced by the user. Responsive to these measurement(s), and a determination of a life-threatening event, the safety device may communicate an emergency alert to a remote system for dispatching one or more responder(s) or otherwise causing assistance to be provided to the user. In an embodiment, the safety device may communicate directly with the remote system or may communicate with the remote system via one or more intermediate devices, such as a mobile device of the user that experienced the lift-threatening event. Upon receiving the emergency alert, the remote system may determine the one or more responder(s) to dispatch or otherwise respond to the user. The responder(s) may carry or have access to a responder device (e.g., mobile device, tablet, etc.) that displays information associated with the emergency alert, the user, and other details that may be useful when responding to the user. The automatic nature of issuing the emergency alerts may serve to increase a response time when responding to the life-threatening events.

In an embodiment, the safety device may represent a device that is worn on the person of the user. For example, the safety device may attach to a hardhat worn by the user. In an embodiment, the safety device may include a housing having attachment mechanisms that removably attach the safety device to the hardhat. Example attachment mechanisms include clips, fasteners, buckles, snap-fits, clamps, magnets, and the like. The attachment mechanisms securely couple the safety device to a bill (e.g., brim) of the hardhat to resist movement of the safety device during use.

However, although discussed herein as coupling to the hardhat, the safety device may couple to other apparel of the user (e.g., vest, toolbelt, hat, etc.), may represent other wearable devices (e.g., necklace, eyewear, lanyard, etc.), or may be worn on different portions of the user (e.g., neck, wrist, arm, etc.). Additionally, the safety device need not be worn on the person of the user, but may represent a device that clips onto equipment (e.g., handheld tools, bucket truck, ladder, etc.) utilized by the user. In such embodiments, the safety device may include respective hardware and features for coupling to these different structures. As such, regardless of the specific implementation, as discussed herein, the safety device is configured to detect the life-threatening events and issue the emergency alerts.

The safety device includes various sensor(s) for detecting an occurrence of a life-threatening event. As used herein, the life-threatening event may include electrocution/shock, fall, arc-flash, struck-by (e.g., impact), or other events that may threaten the life of the user. The sensor(s) are arranged about the safety device for detecting condition(s) of an environment of the user, or the condition(s) experienced by the user. Without limitation, the safety device may include accelerometer(s) for detecting falls or impacts experienced by the user, motion sensor(s) (e.g., magnetometer(s)) for detecting movement of the user, an ultraviolet (UV) sensor for detecting arc-flashes within a vicinity of the user, heat sensor(s) for detecting arc-flashes within a vicinity of the user, microphone(s) for detecting arc-flashes, falls, impacts, etc., and/or magnetic field and/or electrical field detection sensor(s) for detecting electrical shocks (e.g., voltage, current, etc.) experienced by the user. In an embodiment, the magnetic field and/or electrical detection sensor(s) may include one or more capacitively coupled antennas to measure the electric field, one or more inductively coupled antennas to measure the magnetic field, or a magnetometer. These, and other sensor(s), generate sensor data that is measured by the safety device (and/or another communicatively coupled device) for determining whether the user experienced the life-threatening event. In other words, the safety device uses the sensor data to determine whether the user experienced a life-threatening event. In an embodiment, the sensor data may be used to predict the likely occurrence of the life-threatening event prior to such occurrence. In such instances, the emergency alert may be issued.

The safety device may compare the sensor data against threshold(s) for determining the life-threatening event. For example, the safety device may compare the sensor data generated by the accelerometer against a threshold acceleration, may compare the sensor data generated by the UV sensor against a threshold arc-flash (or predetermined amount of brightness, intensity, etc.), and/or the sensor data generated by the magnetic field and/or electrical detection sensor(s) to determine whether the user was electrocuted. In an embodiment, if the sensor data satisfies one or more of the threshold(s), the safety device may generate the emergency alert indicative of the life-threatening event. Additionally, in an embodiment, more than one threshold may be satisfied before generating the emergency alert. For example, to trigger the emergency alert, the sensor data generated by the accelerometer may be compared against a threshold acceleration, and the sensor data generated by the UV sensor may be compared against a threshold brightness. In an embodiment, two thresholds may be satisfied before issuing the emergency alert or determining the life-threatening event. This may create redundancy within the safety device to reliably and accurately detect life-threatening events. However, in an embodiment, more than or less than two thresholds (or more generally, criteria) may be satisfied before issuing the emergency alert.

Moreover, in an embodiment, even if the comparison of the sensor data to a respective threshold indicates the occurrence of a life-threatening event, the safety device may utilize sensor data generated by other sensor(s) to confirm or verify the life-threatening event. For example, if sensor data generated by the UV sensor indicates an arc-flash, the motion sensor(s) may be used to determine whether or not the user is moving following the arc-flash. If the user is not moving, for example, this may confirm the occurrence of the life-threatening event. Moreover, sensor(s) that measure a heart rate of the user may be used to increase the reliability of detecting life-threatening event. As such, different combinations of sensor data may be compared in series, or parallel, with their respective thresholds to detect life-threatening events and issuing emergency alerts.

In an embodiment, the thresholds may have been previously trained from sensor data and/or experimentation to know levels of acceleration, arc-flashes, and electrocution that are life-threatening. The threshold(s) may also be dynamically determined based on characteristic(s) of the user (e.g., weight, age, experience, etc.), conditions of the environment (e.g., sensitivity), types of power systems being worked on, and the like. In other embodiments, the safety device may correlate the sensor data generated by different sensors with one another to determine the occurrence of a life-threatening event. For example, if the sensor data indicates that the user was electrocuted and then fell, the user may have experienced a life-threatening event. As such, patterns may be recognized from the sensor data, or training data, when determining whether to issue the emergency alert.

In an embodiment, machine-learning (ML) techniques may be used to determine a generate ML model(s) that determine a likelihood or probability of the user experiencing a life-threatening event, and if the likelihood or probability exceeds a threshold, the emergency alert may be issued. In such embodiment, the ML model(s) may receive the sensor data as an input, and output an indication (e.g., probability, likelihood, confidence, etc.) of whether or not to issue the emergency alert, or whether the user experienced the life-threatening event. The ML techniques, or models, may have been previously trained to identify, or determine a likelihood of the life-threatening event, from the sensor data for purposes of determining whether to issue the emergency alert.

In an embodiment, the emergency alert may indicate an identifier of the user (e.g., name), a location of the user, the sensor data (e.g., the arc-flash experienced by the user, the acceleration experienced by the user, etc.), and the like. A location sensor of the safety device (e.g., global positioning system (GPS) sensor) may be used to determine the location of the user (e.g., building, room, etc.). The safety device may additionally, or alternatively, include other sensor(s), for determining information associated with the life-threatening event (e.g., timer for determining the time at which the life-threatening event occurred), temperature sensor, heart-rate sensor, etc. Such information may be included within the emergency alert to aid the responder(s) dispatched to the user. Here, these sensor(s) may be used to provide further information to assess the health of the user after experiencing the life-threatening event.

In addition to, or alternative from, the safety device automatically detecting the life-threatening event, in an embodiment, the safety device may include a button (or other input device) that serves as an S.O.S. button. The user, for example, may press or otherwise touch the button for issuing the emergency alert. In an embodiment, the user have may to press and hold the button for a predetermined amount of time (e.g., one second, two seconds, etc.) in order for the safety device to detect the press of the S.O.S. button. In this embodiment, the safety device may or may not have automatically detected the life-threatening event, but the user may have pressed the button to indicate their distress and need of support. On the safety device, the button may be easily locatable for actuation by the user.

Following a press of the button, the user may have a predetermined amount of time (e.g., five seconds, six seconds, ten seconds, etc.) to cancel or override the emergency alert. This may, for example, prevent inadvertent presses of the button for issuing the emergency alert. Otherwise, if the threshold amount of time lapses, the safety device may generate the emergency alert for sending to the remote system. Additionally, or alternatively, the user may also have the ability to terminate transmission of the emergency alert to the remote system within a predetermined amount of time following the detection of the life-threatening event. For example, if the safety device autonomously detects the life-threatening event via the one or more sensor(s), the user may press a button on the safety device (whether the same or different button used for the S.O.S.) to cancel sending of the emergency alert. In an embodiment, rather than pressing the button to issue the emergency alert, the user may issue voice commands (e.g., “Help”, “Emergency”, etc.) that are captured via the safety device (e.g., via microphones) and used to provide assistance to the user. The safety device, or a device communicatively coupled to the device, may process the audio data to identify known commands, predefined words, and so forth. Still, in an embodiment, with a press of the button, the user may mute the emergency alerts output at the safety device.

In an embodiment, the safety device may communicatively couple to a mobile device of the user, and the user may interact with the mobile device to cancel the emergency alert. Here, the user may void transmission of the emergency alert in instances where the life-threatening event was mistakenly detected and/or in instances where the user does not need assistance. For example, the safety device may have fallen off the hardhat of the user. In an embodiment, the safety device may detect the life-threatening-event (e.g., the safety device experienced a fall of a certain magnitude), but the user may not be in need of assistance and the user may want to cancel the emergency alert. Here, allowing the user the ability to terminate issuance of the emergency alert may efficiently utilize emergency services. The emergency alert may be displayed on the mobile device, and the user may have the ability to cancel the emergency alert via the safety device and/or the mobile device.

In an embodiment, the safety device or the mobile device of the user may output a notification (e.g., audible, visual, tactile, etc.) indicating the detected life-threatening event. This notification may inform the user that unless cancelled, the emergency alert will be transmitted to the remote system for responding to the user. For example, the mobile device may display a notification that a life-threatening event was detected and that the emergency alert will be issued within a predetermined amount of time (e.g., countdown). In addition, the mobile device may vibrate, output audio (e.g., chime, alert, siren, etc.) indicating that the emergency alert is being issued unless otherwise terminated. The safety device, additionally or alternatively, may illuminate lighting element(s) (e.g., flash, blink, change colors, etc.) or output audio indicating that the emergency alert is being issued. As noted above, the emergency alert may be cancelled via at least one of the safety device or the mobile device, and in such embodiments, the safety device and the mobile device may be in communication to determine whether the emergency alert was cancelled.

Responsive to generating the emergency alert, and after the predetermined amount of time has elapsed without received an input to cancel the emergency alert, the emergency alert may be sent to the remote system. In an embodiment, the safety device may include one or more network interfaces (e.g., satellite, cellular, Wi-Fi, Bluetooth, BLE, etc.) for directly wirelessly communicating with the remote system. Additionally, or alternatively, the safety device may communicate with one or more devices (e.g., cell phone, tablet, laptop, desktop computer, etc.), such as the mobile device of the user, for transmitting the emergency alert to the remote system. For example, the mobile device may act as an intermediary between the safety device and the remote system. Upon detection of the life-threatening event, the safety device may communicate with the mobile device, and likewise, the mobile device may communicate with the remote system. In an embodiment, the mobile device may communicate with other devices, such as device(s) of responder(s), for issuing the emergency alert and/or informing others of the life-threatening event.

In an embodiment, the safety device may communicate with the mobile device via a first communication protocol (e.g., Bluetooth, BLE, etc.), and the mobile device may communicate with the remote system via a second communication protocol (e.g., cellular, Wi-Fi, etc.). Other devices, however, may be used in the communication pathway between the safety device and the remote system. For example, service vehicles having electronic device (e.g., laptops) may provide a pathway for communicating the emergency alert between the safety device and the remote system.

Generally, the emergency alert may serve as a notification of the life-threating event experienced by the user. The remote system may utilize the emergency alert for determining how to respond to the life-threating event, such as responder(s) to dispatch to the user and/or procedures for assisting in the experienced life-threatening event. In an embodiment, the remote system determines the responder(s) based on information contained within a user profile associated with the user, a profile associated with a company of the user, based on the type of life-threatening event experienced by the user, the location of the user, and so forth. For example, the remote system may store a database of user profiles, and upon receiving the emergency alert, an identifier of the safety device and/or an identifier of the user may be used to access the user profile of the user. The user profile may indicate a list of contacts (e.g., supervisor, family, friends, colleagues, etc.) that are to be contacted upon experiencing a life-threatening event. The user profile may also indicate medical information associated with the user, such as allergies or a medical history, or other demographic information that may be useful in responding to the life-threatening event and providing care to the user.

Additionally, or alternatively, the remote system may determine the responder(s) or a response to the emergency alert based on response profiles. The response profiles may include a stored set of procedures, protocols, etc. that are carried out when the life-threatening event is detected. In an embodiment, the response profiles may be associated with the user, a company of the user, the type of life-threatening event experienced by the user, and so forth. For example, the response profiles may indicate the number of responders to dispatch (e.g., one, two, four, etc.), instructions to transmit to the responder(s) for responding to the life-threatening event (e.g., issuing CPR, calling 911, etc.), an order in which to contact the responder(s) (e.g., first responder, second responder, etc.), an experience of the responder(s), qualifications or trainings of the responder(s), and the like. As an example, a first responder may be contacted and/or dispatched based on the user being electrically shocked, while a second responder may be contacted and/or dispatched based on the user experiencing a fall. Each of the life-threatening events may include their respective response needs, and the responder(s) and/or the procedures may be selected based on the type of life-threatening event.

The remote system may also determine the responder(s) based on the proximity of the responder(s) to the user. For example, knowing the location of the user (or a worksite of the user), the remote system may dispatch responder(s) that are geographically proximate to the user. The location of the responder(s) may be known from the responder(s) wearing safety devices, or may be known from mobile devices of the responders. In an embodiment, the remote system may receive the location of the responders for knowing their location relative to the user. This may allow the remote system to select those responder(s) which are closest in location to the user to reduce response times. The remote system may continuously and/or automatically receive locations of the responders, or may obtain (e.g., ping) the location of the responders in response to receiving the emergency alert.

Once the responder(s) are determined, the remote system may transmit notifications to the responder(s). In an embodiment, the notifications may be displayed or otherwise output (e.g., speaker(s)) on responder devices associated with the responder(s), respectively. For example, the notification may identify the user, the location of the user, the time at which the life-threatening event occurred, the life-threatening event experienced by the work, sensor data generated by the sensor(s) of the safety device of the user, and the like. The notifications may also cause the responder devices to vibrate, output audio, or illuminate to certain appearance states to garner the attention of the responder(s).

Responsive to the notification, the responder(s) may travel to the user, begin providing assistance, and/or observing the user. In an embodiment, the remote system may track the location of the responder (via the responder device) to determine whether the responder is traveling to the user. If the responder becomes delayed, or is unable to travel to the user within a threshold amount of time, the remote system may determine other responder(s) to respond to the user. In an embodiment, and as part of assisting the responder in traveling to the user, the responder device may also display directions to navigate the responder to the user.

Additionally, the notification may indicate response procedures for helping the user, such as performing CPR, checking for pulses, checking for breathing, consciousness, and the like. In an embodiment, these response procedures may be a checklist that the responder(s) perform, or walkthrough, once arriving on scene and examining the user. Further, the response procedures may be displayed as a series of interactive user interfaces (UIs) that assist the responder(s) in providing care to the user. Still, the response produces may be displayed as a questionnaire for diagnosing the user. Such information, for example, may ask whether the user is conscious, breathing, alert, and the like. In an embodiment, the responder may first provide an indication that they will, or are available to, assist the user and thereafter, the remote system may transmit the response procedures. The inputs provided by the responder(s) may be used by the remote system, for example, to dispatch emergency services to the user and/or determine other procedures for responding to the user.

Although the emergency alert is described as being transmitted to the remote system after the predetermined amount of time, in an embodiment, the remote system may be made aware of the emergency alert, but may not issue (e.g., broadcast) the emergency alert to the one or more responders until after the predetermined amount of time has lapsed without the emergency alert being canceled. As such, in response to detecting the life-threatening event, the emergency alert may be sent to the remote system, but the remote system may not dispatch the one or more responder(s) until the predetermined amount of time has elapsed without received an input to cancel the emergency alert. In this sense, the remote system may queue a response to the emergency alert, but the issuance of that emergency alert may not be sent to the responder(s) until after the predetermined amount of time has elapsed.

Additionally, in an embodiment, rather than the mobile device communicating with the remote system for issuing the emergency alert, the mobile device may communicate directly with the responder devices. For example, a user profile of the user may be stored on an application of the mobile device, and in response to detecting the life-threatening event, responder(s) may be determined via the user profile. As such, the mobile device may communicate with the responder(s) for informing the responder(s) of the life-threatening event of the user. In an embodiment, the user has the ability to change or otherwise edit the responder(s) via their user profile.

In an embodiment, the remote system may track and record the life-threatening events as a way to provide reports associated with the users. For example, the remote system may record the occurrence, frequency, severity, and the like of the life-threatening evenings. Reports may be generated that indicate those users that are susceptible to life-threatening events. This may be used, for example, to provide training to the users, reprimand the users, and the like. As such, the reports may indicate the safeness of certain users or companies associated with the users. Additionally, the sensor data generated by the sensor(s) of the safety device may be used to update thresholds for use in detecting life-threatening events.

The remote system may also track and record communications associated with the user and/or the responder(s). For example, as the responder(s) arrive on scene and provide assistance to the user, the responder(s) may indicate (via the responder device) the assistance provided or the measures taken to provide assistance to the user (e.g., pulse, CPR, etc.). This information may be stored by the remote system to provide a transcript, data log, etc. of the life-threatening event for training or investigative purposes. Additionally, the responder(s) may communicate within a chatroom or other messaging platform about the emergency alert. This may centralize information about the emergency alert and keep the responder(s) up to date and informed of the current state of the user. Additionally, this may reduce redundant actions on part of the responder(s), such as calling 911. For example, in response to issuing the emergency alert, the remote system may establish a communication channel between the user and the responder(s), and invite the user and the responders to communicate via the communication channel. This communication channel may be updated in real-time based on communications, as well as sensor data generated via the sensor(s) of the safety device.

For example, after the emergency alert has been issued, the communication channel may indicate whether sound within the environment of the user was captured, whether motion of the user was detected, the heart rate of the user, the temperature of the user, and so forth. This may be used to provide information used to assess the condition of the user event after the emergency alert was issued and the life-threatening event was detected.

In addition to issuing the emergency alerts and providing the notifications to the responder(s), the remote system may determine and/or perform action(s) to assist the user and/or decrease the severity of the life-threatening event. For example, the remote system may cause the power systems to deactivate to reduce further injury to the user. Additionally, if the user is operating a boom to work on the power systems, the remote system may cause the boom to automatically lower to a ground surface (e.g., via communication with the boom or a piece of equipment associated with the boom). In an embodiment, indications of the action(s) may be provided to operators, who, in turn, carry out the action(s) (e.g., disconnected equipment to remove power from the power system).

In an embodiment, the safety device may also track and record the events leading up to the detection of the life-threatening event. For example, the safety device may store the sensor data based on the detection, or lack of detection, of the life-threatening event. Such sensor data, for example, may be useful in determining the environments and conditions of the user in the field. The sensor data may also be used to predict or detect future instances of life-threatening events. For example, the sensor data leading up to the life-threatening event may be useful in predicting future life-threatening events and warning the user as to potential dangers. These indications may be used to recalibrate the threshold(s) for issuing the emergency alerts or providing warnings to the user as to the imminent dangers. Such pattern(s) may be recognized by the ML model(s).

In an embodiment, the safety device may store the sensor data for a predetermined amount of time, and if a life-threatening event is not detected, may delete the sensor data. Alternatively, if the life-threatening event is detected, the sensor data may be stored and/or sent to the remote system. Still, even after the life-threatening event is detected, the safety device may continue to record sensor data. This may be used, for example, to determine whether the user is motionless or moving. Such information may be provided to the responder(s) for informing them of the status of the user.

The safety device may include other input and output component(s) that provide other warnings to the user within the environment. For example, the safety device may include a series of lighting elements (e.g., light bar) that illuminate based on a detected directionality and/or intensity of an energized conductor. The lighting elements may provide a visual indication to the user as to the detected location the energized conductor. Such visual indications may serve to warn the user of potential dangers, prior to the user being injured. For example, the magnetic and/or electric field detection sensors, or other sensors (e.g., antennas(s)), may detect nearby energized conductors for alerting the user to the presence thereof. Such notifications are issued with the intent to reduce the occurrence of injuries due to electrocution. In an embodiment, the location of the energized conductor may be detected by converting an analog signal into a digital signal. However, although describe as output notifications via the lighting elements, the safety device may additionally or alternatively output haptic (e.g., vibrational motor), audible (e.g., speaker(s)), or other feedback to alert the user when approaching and/or entering a particular proximity of the energized conductor

The lighting elements may also illuminate to difference states (e.g., color, pattern, intensity, etc.) based on safety device detecting the life-threatening event, the responder(s) being dispatched, the responder(s) arriving on scene, and the like. Additionally, the safety device may include speaker(s) for outputting notifications to the user, such as indicating to the user that help is on the way, telling the user to remain calm, and the like. The safety device may also include microphone(s) for capturing speech of the user (or the responders). The speaker(s) and the microphone(s) may allow the user to communicate with the responder(s), operators associated with the remote system, and/or other personnel.

The safety device may record on memory, built into the warning device, data regarding the use of the safety device, and/or as mentioned above, the sensor data generated by the sensors. Such data may include, but is not limited to, the identification of the user, the duration of use, the manner of use (e.g., orientation of the safety during use, quantity of emergency alerts issued, user compliance to warning notifications, etc.), errors encountered, geographic locations of the safety device, geographical location(s) where warning notifications were issued, etc. This data may be collected and organized by the safety device and/or by the remote system. The data may include information to analyze work-place safety metrics to evaluate the safety practices of users.

In an embodiment, the safety device may be configured to operate between different power modes in order to conserve battery life. For example, when the safety device is monitoring for life-threatening events, the safety device may be in a low-power mode. If and when the safety device detects the life-threatening event, the safety device may switch into a high-power mode in which increased power is demanded. This increase power demand may be used to power network interface(s), the location sensor, and so forth of the safety device. As such, when the life-threatening event is detected, or the safety device issues the emergency alert, the safety device may transition into another mode for communicating with the user device.

The systems and methods disclosed herein may therefore accurately detect life-threatening events and reduce response times to the life-threatening events. For example, the safety device includes sensor(s) that are used to determine the occurrence of the life-threatening event, and based on such determination, may communicate an emergency alert to the remote system. In turn, the remote system may determine responder(s) to respond or otherwise assist the user, as well as provide the responder(s) with response procedures for assisting the user. The life-threatening event, the conditions experienced by the user, information associated with the user, as well as actions undertaken by the responder(s) may be tracked and recorded for training purposes to reduce the occurrence of life-threatening events in the future.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting examples. The features illustrated or described in connection with one example may be combined with the features of other examples. Such modifications and variations are intended to be included within the scope of the appended claims.

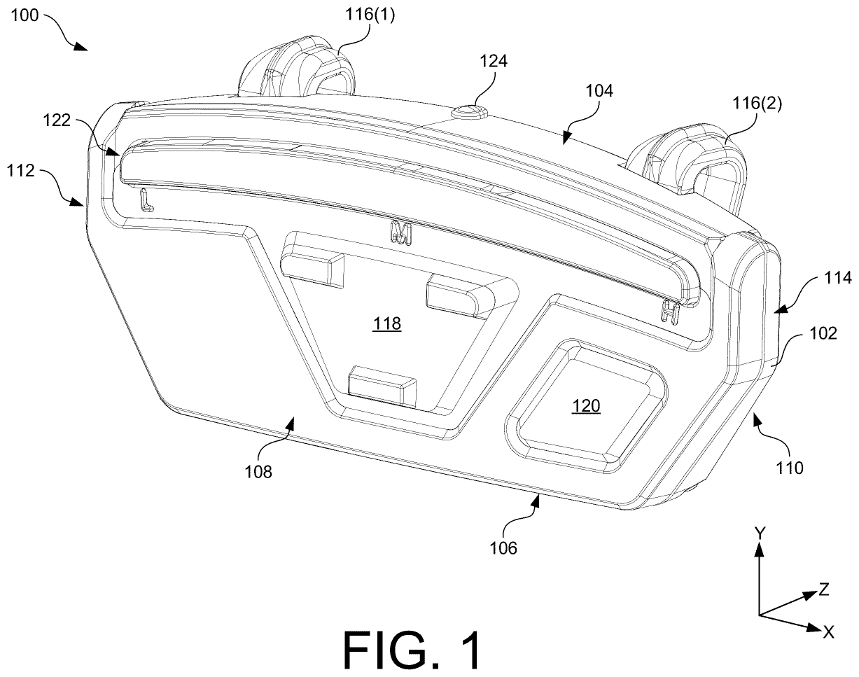

FIG. 1 illustrates a perspective view of an example safety device 100. The perspective view illustrated in FIG. 1 may represent a front of the safety device 100, for example, oriented towards a user wearing the safety device 100.

The safety device 100 may include a housing 102. In embodiment, the housing 102 is formed of two sections (e.g., pieces, halves, etc.) that are coupled together (e.g., via snap-fit, adhesives, fasteners, etc.). The safety device 100, or the housing 102, may form a watertight enclosure. In an embodiment, the housing 102, or more generally the safety device 100, includes a top 104, a bottom 106 spaced apart from the top 104 (e.g., in the Y-direction), a front 108, a back 110 spaced apart from the front 108 (e.g., in the Z-direction), a first side 112, and a second side 114 spaced apart from the first side 112 (e.g., in the X-direction). Example materials for the housing 102 include plastics, composites, and/or any combination thereof.

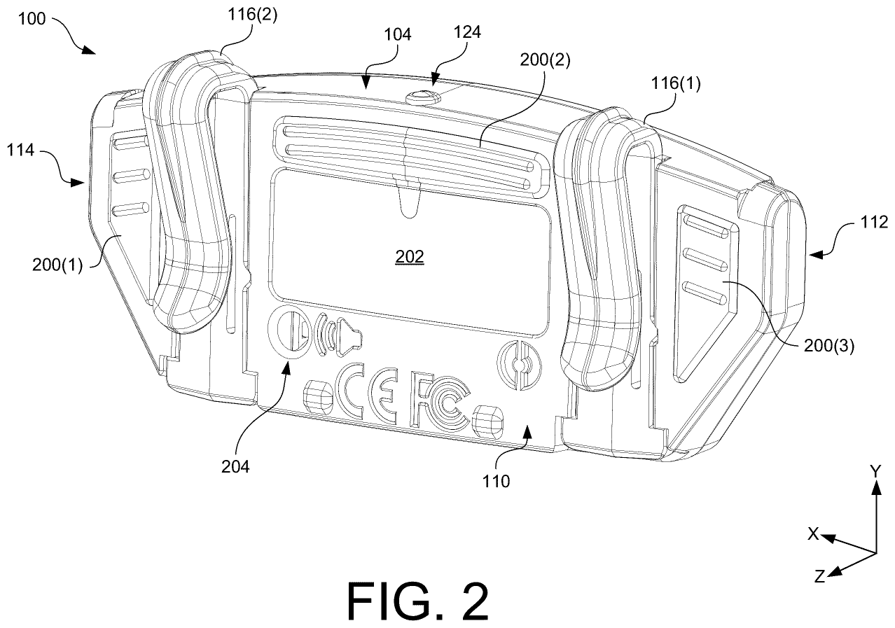

In an embodiment, the housing 102 couples to a hardhat worn by a user (e.g., worker, supervisor, foreman, etc.). For example, attachment mechanisms 116, such as a first attachment mechanism 116(1) and a second attachment mechanism 116(2), may secure to the housing 102 for coupling the safety device 100 to the hardhat of the user. As will be discussed in more detail in FIG. 2, the attachment mechanisms 116 may represent clips that are biased (e.g., in the Z-direction) to clip onto a bill of the hardhat. Once clipped onto the bill of the hardhat, for example, the attachment mechanism 116 may maintain an engagement with the hardhat and secure the safety device 100 to the hardhat. This may prevent the safety device 100 shifting, reorienting, or otherwise repositioning during use.

The front 108 is shown including a first button 118 and a second button 120. The first button 118 may correspond to a menu button of the safety device 100, and may be depressed to change settings of the safety device 100 (e.g., volume, sensitivity, etc.). Additionally, depressing the first button 118 (e.g., in the Z-direction) for varying amounts of time (e.g., pressing and holding) may cause the safety device 100 to perform different functions (e.g., pair with other devices, change settings, battery level indicator, etc.). In an embodiment, the first button 118 may represent a mute/unmute button that is depressed to output or mute audio output by speaker(s) of the safety device 100. Still, in an embodiment, the first button 118 may be depressed for different amounts of time to access certain functionalities of the safety device 100 and/or to change setting(s) (e.g., voltage sensitivities/thresholds, current sensitivities/thresholds, etc.).

The second button 120 may correspond to an alert button (e.g., S.O.S. button). Depressing the second button 120 (e.g., in the Z-direction), may cause the safety device 100 to communicate with a remote system, responder device(s), or other communicatively coupled devices for providing assistance to the user. For example, if the user is electrocuted, shocked, falls, or experiences another life-threatening event, the user may press the second button 120 to issue an emergency alert. As will be discussed in further detail herein, however, the safety device 100 may include sensor(s), and using sensor data generated by the sensor(s), may automatically detect or predict the life-threatening event. As such, the safety device 100 may issue the emergency alert following a detection via one or more onboard sensor(s), and/or may issue the emergency alert following a press of the second button 120. Other techniques, however, may be implemented for responding to the life-threatening events. For example, the safety device 100 may have microphone(s) that capture user speech for use in determining the life-threatening events.

The first button 118 and the second button 120 are shown located on the front 108, however, in other embodiments, the first button 118 and/or the second button 120 may be located on other sides or surfaces of the housing 102, differently than shown, and/or more than or less than two buttons may be included. The first button 118 and/or the second button 120 may also include a different shape and/or size as shown. Additionally, as discussed in detail herein, the front 108 may be visible and accessible (e.g., reachable) to the user wearing the safety device 100 such that the user may press the first button 118 and/or the second button 120.

The front 108 is further shown including a light indicator 122. The light indicator 122 may extend in a direction between the first side 112 and the second side 114. In an embodiment, the light indicator 122 may be positioned closer to the top 104 of the safety device 100 as compared to the first button 118 and/or the second button 120. As discussed herein, lighting element(s) disposed behind the light indicator 122 (e.g., in the Z-direction) may illuminate to provide a warning notification (e.g., alert, alarm, warning, etc.) when the user approaches an energized conductor. Further, the warning notification may provide an approximate direction of the energized conductor relative to an orientation of the safety device 100. As discussed herein, to detect the energized conductor, the safety device 100 includes one or more field detection sensors configured to detect at least one of an electric field signal or a magnetic field signal. Such warning notification serves to warn the user as to the possible dangers within an environment and in advance of any potential injury.

The top 104 is shown including a UV sensor 124 that is configured to detect arc-flashes within an environment of the user. The UV sensor 124 may detect the arc-flashes within a certain range of the user, or whether the arc-flashes were within a close proximity of the user. When worn by the user, for example, the UV sensor 124 may be outward facing in a direction away from the user in order to detect arc-flashes (e.g., in front of the user, within a field of view of the user, etc.). In an embodiment the UV sensor 124 may be located differently than shown, and/or the safety device 100 may include more than one UV sensor. The UV sensor 124 may include a light pipe and/or a lens that directs the light onto the UV sensor located within the housing 102.

Generally, the UV sensor 124 represents a photodiode, and when light strikes the photodiode, electrons are energized. In turn, an electric current is generated. The electric current will be stronger in response to brighter light striking the photodiode. The electrical current is measured and transformed into either a digital and/or an analog output. In an embodiment, the safety device 100 is configured to compare the output to a threshold to determine whether an arc-flash occurred and/or whether the user is within a certain distance of the arc-flash. For example, if the electrical current generated by the UV sensor 124 is less than a threshold (which is associated with a threshold amount of light), the safety device 100 may determine a lack of arc-flash or that the arc-flash was remote from the user. Alternatively, if the electrical current generated by the UV sensor 124 is greater than the threshold, the safety device 100 may determine the occurrence of the arc-flash and that the user may be in danger (e.g., given the proximate location of the arc-flash to the user). In such embodiments, the safety device 100 may determine to issue an emergency alert given the occurrence of the arc-flash and the proximity of the user. This may represent a life-threatening event experienced by the user, and responder(s) may be contacted for assisting the user.

Although discussed herein as coupling to a hardhat, the safety device 100 may represent other wearable devices that are securable to the user, or which are otherwise wearable by the user. For example, magnets, hook and loop, receptacles in the hardhat, and so forth may be used to couple the safety device 100 to the user. Alternatively, in an embodiment, the safety device 100 may not be worn by the user. For example, the safety device 100 may attach to equipment used by the user (e.g., ladder, lift bucket, machinery), structures positioned about an environment of the user (e.g., gantry, poles, etc.), and so forth. As such, while the figures may depict an embodiment of the safety device 100, it is contemplated that one or more features and concepts described herein may be implemented in other non-wearable embodiments. In such embodiments, the safety device 100 may include a corresponding structure or features to permit the operation of the safety device 100 as discussed herein.

FIG. 2 illustrates a perspective view of the safety device 100. The perspective view illustrated in FIG. 2 may represent a rear of the safety device 100. For example, when worn on the hardhat of the user, the back 110 of the safety device 100 may be disposed immediately adjacent to the brim of the hardhat (e.g., underneath side of the brim of the hardhat).

As shown, the first attachment mechanism 116(1) and the second attachment mechanism 116(2) are disposed on the back 110 for coupling the safety device 100 to the hardhat. As introduced above, the first attachment mechanism 116(1) and the second attachment mechanism 116(2) may represent clips that are biased (e.g., in the Z-direction) to clamp the safety device 100 onto the hardhat. However, other securing mechanisms are envisioned, the first attachment mechanism 116(1) and/or the second attachment mechanism 116(2) may be located on the safety device 100 differently than shown, and/or the safety device 100 may include a greater or less number of attachment mechanisms 116 than shown.

The safety device 100 may also include gripping elements 200, such as a first gripping element 200(1), a second gripping element 200(2), and/or a third gripping element 200(3). The first gripping element 200(1), the second gripping element 200(2), and/or the third gripping element 200(3) are shown being disposed across the back 110, and may contact the brim of the hardhat when the safety device 100 clips onto the hardhat. In an embodiment, the first gripping element 200(1), the second gripping element 200(2), and/or the third gripping element 200(3) may be made of rubber, silicone, leather, or other materials that resist movement of the safety device 100 relative to the hardhat. In doing so, when the first gripping element 200(1), the second gripping element 200(2), and/or the third gripping element 200(3) contact the brim of the hardhat, the first gripping element 200(1), the second gripping element 200(2), and/or the third gripping element 200(3) may resist movement and securely position the safety device 100 on the hardhat. Although three gripping elements are shown, the safety device 100 may include more than or less than three gripping elements 200, and/or the gripping elements 200 may be located on the safety device 100 differently than shown.

The UV sensor 124 is shown disposed on the top 104 of the safety device 100. In an embodiment, the UV sensor 124 may be located more proximate to the back 110 than the front 108 (e.g., in the Z-direction). A cover (e.g., transparent dome) may be disposed over the UV sensor 124 to prevent debris or damage contacting the photodiode(s) of the UV sensor 124.

The back 110 is further shown including a cover 202 and a port 204. The cover 202 may be removable to provide access to an interior of the housing 102. For example, one or more batteries may be located interior to the housing 102, and removing the cover 202 may provide access to the batteries (e.g., for replacement, recharging, etc.). The port 204 emits sound from speaker(s) of the safety device 100, and permits the sound to travel from within the safety device 100 to an exterior of the safety device 100. In an embodiment, the port 204 may be located on the front 108, and/or the housing 102 may include more than one port 204 for emitting sound generated by the speaker(s).

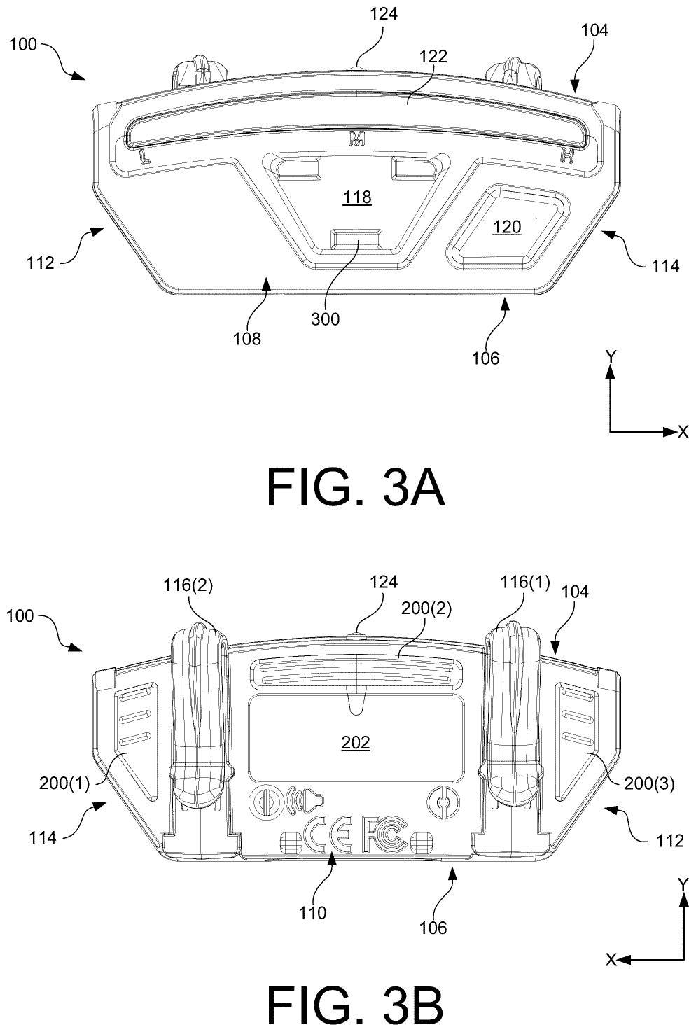

FIG. 3A and FIG. 3B illustrate side views of the safety device 100. FIG. 3A illustrates the front 108 of the safety device 100, while FIG. 3B illustrates the back 110 of the safety device 100.

In an embodiment, the housing 102 includes a substantially-rectangular shape. However, the top 104 may be curved (e.g., arc, curvature, etc. in the Y-direction) between the first side 112 and the second side 114. In an embodiment, the curvature of the top 104 may substantially match or correspond to a curvature of the brim of the hardhat. In an embodiment, the top 104 may include a greater length (X-direction) than a length of the bottom 106 (X-direction). Additionally, the first side 112 and the second side 114 may taper inwards, from the top 104 to the bottom 106. Different shapes, contours, or profiles are envisioned.

The front 108 is shown including the light indicator 122 to provide visual warnings to the user as to a detected field signal, as well as a directionality of where field signal originates. In an embodiment, the light indicator 122 may similarly curve between the first side 112 and the second side 114, so as to match a curvature of the top 104. In an embodiment, indicia (e.g., L (low), M (medium), H (high)) may be disposed adjacent to the light indicator 122. The indicia may indicate a strength (e.g., intensity, energy, etc.) of the field signal (e.g., voltage, current, etc.). For example, if the detected field signal is “low,” the light indicator 122 may be illuminated adjacent to the “L” indicia. The light indicator 122, or lighting element(s) residing beneath the light indicator 122, may also output indications based on detecting life-threatening events and/or emergency alerts being issued.

The front 108 is further shown including the first button 118 and the second button 120 for muting a safety warning and issuing an emergency alert, respectively. In an embodiment, the first button 118 may be centered between the first side 112 and the second side 114 (e.g., in the X-direction). The first button 118 may also include knobs 300 that assist in centering a finger of the user on the first button 118. This may allow the user to easily locate and depress the first button 118. The second button 120 is shown being located more proximate to the second side 114 than the first side 112, and more proximate to the bottom 106 than the top 104. However, other variations (e.g., size, location, number, etc.) of the first button 118 and/or the second button 120 are envisioned.

The back 110 includes the first gripping element 200(1), the second gripping element 200(2), and/or the third gripping element 200(3). The first gripping element 200(1) is shown being located between the second side 114 and the second attachment mechanism 116(2), the second gripping element 200(2) is shown being located between the first attachment mechanism 116(1) and the second attachment mechanism 116(2), and the third gripping element 200(3) is shown being located between the first attachment mechanism 116(1) and the first side 112. In an embodiment, the second gripping element 200(2) may be located between the cover 202 and the top 104. The second gripping element 200(2) may also be centered between the first side 112 and the second side 114 (e.g., in the X-direction).

The UV sensor 124 is shown disposed along the top 104. In an embodiment, the UV sensor 124 may be centered between the first side 112 and the second side 114 (e.g., in the X-direction). As shown, the UV sensor 124 is oriented in a direction away from the bottom 106 of the safety device 100, so as to detect arc-flashes within a field-of-view of the user and when coupled to the hardhat (e.g., so as to face outward from the user).

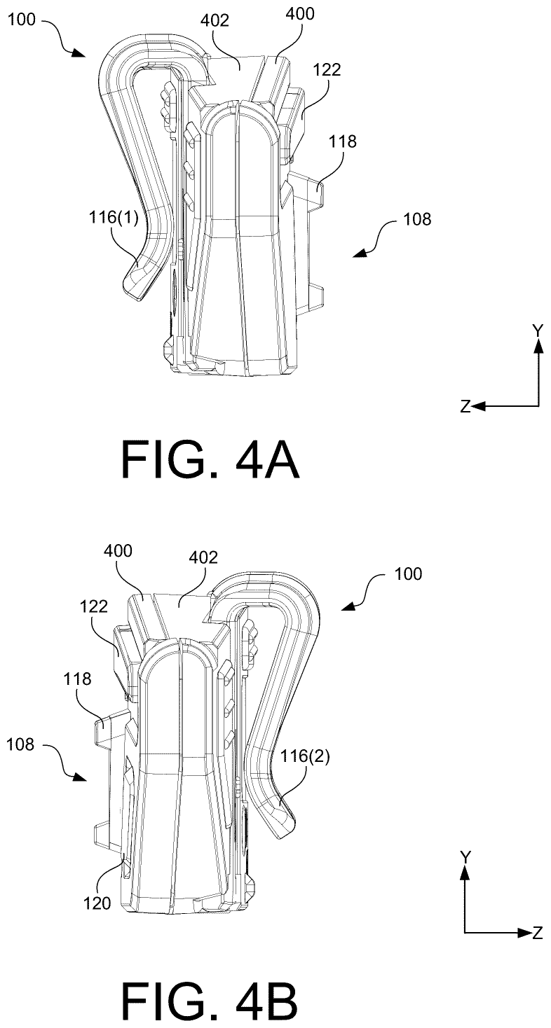

FIGS. 4A and 4B illustrate end views of the safety device 100. For example, FIG. 4A illustrates an end view of the first side 112, and FIG. 4B illustrates an end view of the second side 114 of the safety device 100.

As introduced above, the housing 102 may be formed from multiple sections that are coupled together, such as a first section 400 (e.g., first half) and a second section 402 (e.g., second half). The first section 400 may be located on the front 108 of the safety device 100, while the second section 402 may be located on the back of the safety device 100. The first section 400 and the second section 402 may be coupled together, so as to form the housing 102, via fasteners, adhesives, snap-fit, and/or any combination thereof. The first section 400 and the second section 402 may also define an interior cavity within which components of the safety device 100 reside (e.g., processor(s), lighting element(s), battery, FPGA, etc.).

The light indicator, the first button 118, and the second button 120 are shown extending from the front 108, while the first attachment mechanism 116(1) and the second attachment mechanism 116(2) are shown extending from the back 110.

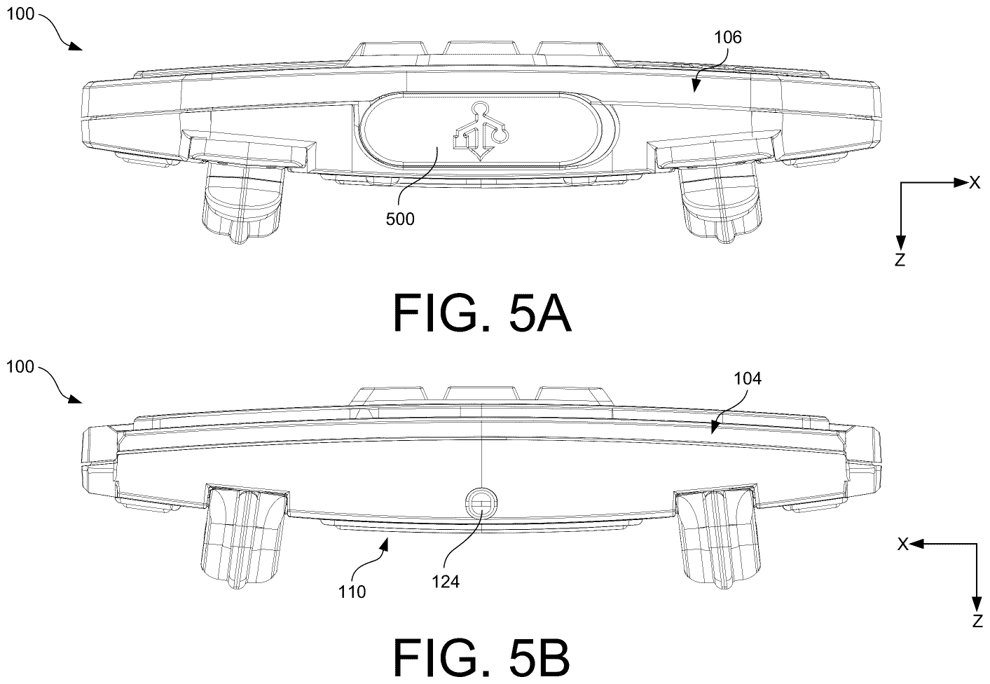

FIGS. 5A and 5B illustrate the bottom 106 and the top 104 of the safety device 100, respectively. The bottom 106 may include a cap 500 secured to the housing 102 (e.g., the second section 402). The cap 500 may provide access to one or more connection ports of the safety device 100. For example, the safety device 100 may include a charging port, a universal serial bus (USB) port, a micro USB port, an auxiliary port, and the like. The connection ports, for example, may charge batteries located within the safety device 100, may be used to update software of the safety device 100, and/or may be used to transfer data from the safety device 100 (e.g., sensor data generated via sensor(s) of the safety device 100). For example, although the safety device 100 may be equipped with wireless network interface(s) for communicatively coupling to one or more device(s), the safety device 100 may be equipped with a hardwire connection in order to transfer the data out of/from the safety device 100. In an embodiment, after transferring the data, memory of the safety device 100 may be wiped and reset to store additional data. In an embodiment, the cap 500 (and/or the connecting ports), may be centrally located on the safety device 100 (e.g., between the first side 112 and the second side 114. Additionally, the cap 500 may seal the connection ports to prevent ingress of liquid or other debris into the housing 102. Although shown as located on the top 104, the connection ports may be located elsewhere on the safety device 100 (e.g., the first side 112, the second side 114, etc.).

The UV sensor 124 is further shown located on the top 104, between the front 108 and the back 110 of the safety device 100.

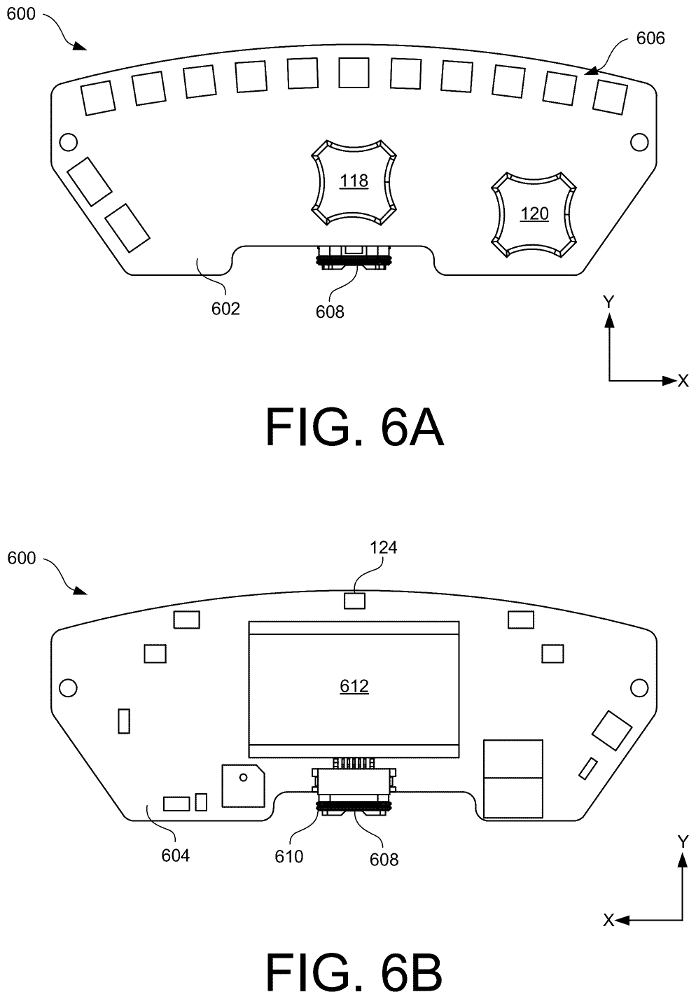

FIGS. 6A and 6B illustrate various views of a printed circuit board 600 (PCB) of the safety device 100. For example, the PCB 600 may reside at least partially within the housing 102 of the safety device 100. The PCB 600 may include various semiconductors, connectors, resistors, diodes, capacitors, and the like for carrying out a functionality of the safety device 100. In an embodiment, the PCB 600 may represent a multilayer PCB, or a double-sided PCB. However, although described herein as a PCB, the safety device 100 may include a flexible printed circuit boards (FPCBs), flex circuits, flexible printed circuit assemblies (FPCAs), and the like.

The PCB 600 includes a first side 602 and a second side 604 opposite the first side 602. The first side 602 is oriented towards the front 108 of the safety device 100, and the second side 604 is oriented towards the back 110 of the safety device 100. The first side 602 may include the first button 118 and the second button 120. In an embodiment, the first button 118 and/or the second button 120 may be mechanical type buttons, capacitive type buttons, resistive type buttons, and so forth. Additionally, the first side 602 may include a plurality of lighting element(s) 606, which are located vertically beneath (e.g., behind) the light indicator 122 (e.g., in the Z-direction). The lighting element(s) 606 may include light emitting diodes (LEDs), organic light emitting diodes (OLEDs), and the like. The lighting element(s) 606 are arranged on the first side 602 to output light in a direction towards the light indicator 122 to provide visual warnings to the user as to a detected field signal, as well as a directionality of where field signal originates. In an embodiment, the safety device 100 may include diffusers or light guides to reduce “hot spots” of light emitted by the lighting element(s) 606. The lighting element(s) 606 may also illuminate to indicate the life-threatening event or the emergency alert being issued (as explained herein).

The lighting element(s) 606 are capable of being individually and collectively controlled. The lighting element(s) 606 may output different colors of light, and/or different intensities of light. The lighting element(s) 606 may also be controlled to blink, flicker, illuminate to certain patterns, illuminate for predetermined periods of time, etc. However, the lighting element(s) 606 may be controlled in other manners as well. Additionally, although a particular number of lighting element(s) 606 are shown, a greater or lesser number of the lighting element(s) 606 may be included. The lighting element(s) 606 may also be located on the PCB 600 differently than shown.

The PCB 600 further includes a connection port 608, which as discussed above, may be located beneath the cap 500 (e.g., when the cap 500 is removed). The connection port 608 may include a USB port, a micro USB port, an auxiliary port, etc. One or more seals 610 may be located around the connection port 608 for sealing the connection port 608 to the housing 102 (e.g., the second section 402).

A battery 612 may be located on the second side 604. The battery 612 may include a rechargeable or replaceable battery. The battery 612 communicatively couples to various components of the safety device 100 (e.g., the lighting element(s) 606, the UV sensor 124, etc.). The second side 604 may include additional components, such as speaker(s) that output audio (e.g., through the port 204), antenna(s), accelerometer(s), field detection sensor(s), microphone(s), temperature/heat sensor(s), network interface(s) (e.g., Wi-Fi, satellite, Bluetooth, etc.), and the like. Additionally, although certain components are shown being respectively located on the first side 602 and the second side 604, the components may be located differently than shown.

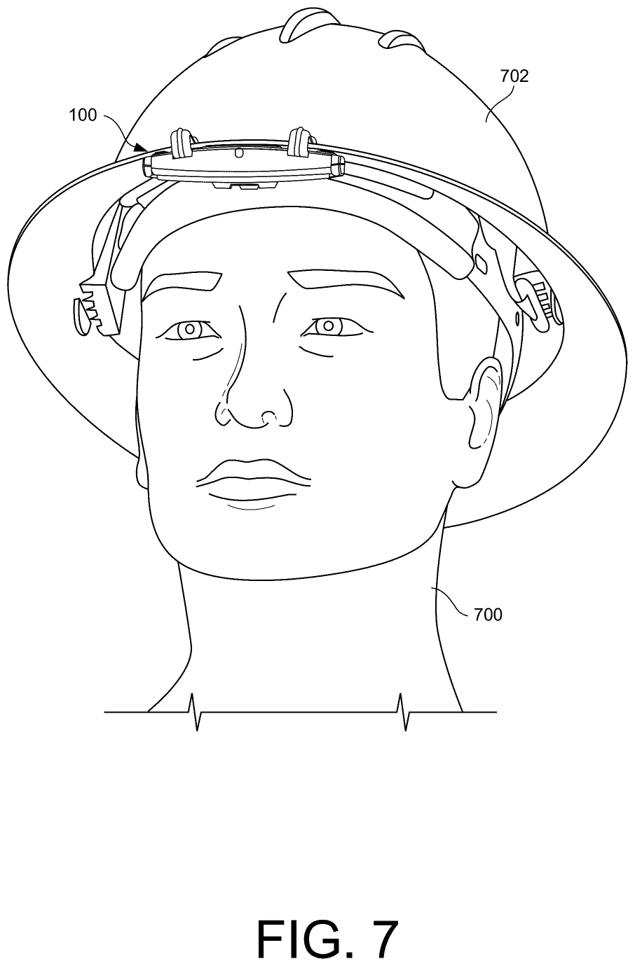

FIG. 7 illustrates a user 700 wearing the safety device 100, or more particularly, the safety device 100 being coupled to a hardhat 702 worn by the user 700.

As discussed above, the first attachment mechanism 116(1) and the second attachment mechanism 116(2) may clip onto a brim of the hardhat 702 to dispose the safety device 100 within a field of view of the user 700 to allow the user 700 to view warning notification(s) emitted by the light indicator 122 (e.g., detected field, emergency alert, etc.). Additionally, the placement of the safety device 100 permits the user 700 to press the first button 118, the second button 120, and/or otherwise conveniently interact with the safety device 100. As such, the safety device 100 may be sufficiently compact to be worn in a variety of places without inconveniencing the user 700 or causing uncomfortableness.

Even though FIG. 7 illustrates the safety device 100 being clipped onto the hardhat 702, the safety device 100 may be configured to be worn elsewhere on clothes or a body of the user 700 (e.g., via the same or similar clipping action, and/or via a different clipping action). The safety device 100, in such instances, may be structured in other configurations (different than shown) with different attachment mechanisms (not shown). However, in these and other alternative embodiments, it is contemplated that features and processes executed by the safety device 100 may be the same or similar to those described herein. Moreover, it is also understood that in such alternative embodiments, that the processes described herein may be modified compared to those described herein below to compensate for the change in structure and/or difference in relative positioning, etc.

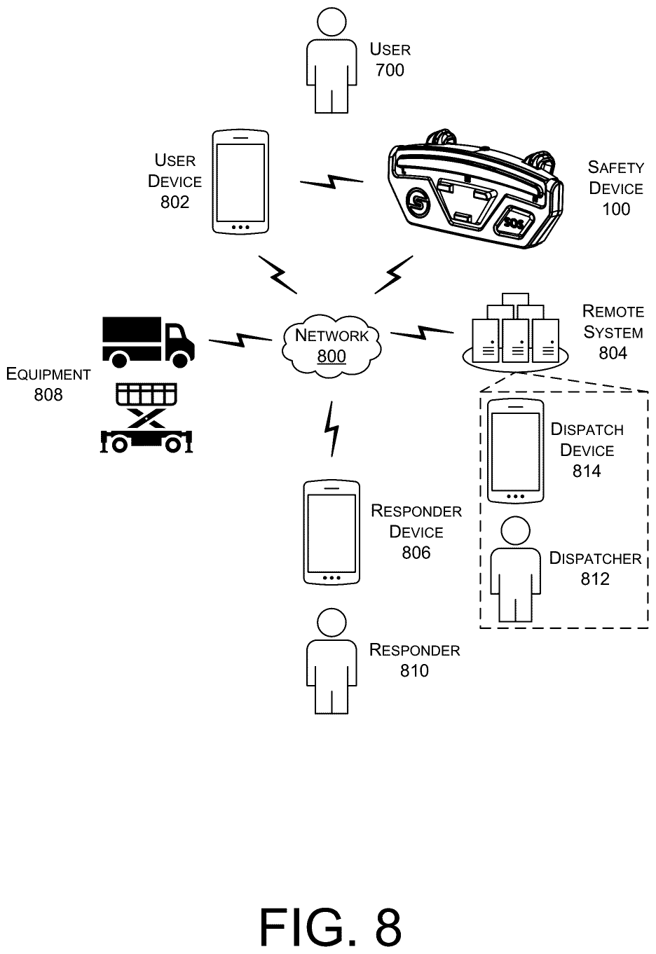

FIG. 8 illustrates a communicatively coupling between the safety device 100 and other devices, equipment, and the like over network(s) 800. For example, via the network(s) 800, the safety device 100, a user device 802, a remote system 804, a responder device 806, and/or equipment 808 may communicatively couple with one another.

As will be discussed herein, in an embodiment, the safety device 100 may communicate with the remote system 804 in response to the safety device 100 detecting a life-threatening event. For example, if the user 700 falls, is electrocuted/shocked, an arc-flash is detected, and/or another life-threatening event is detected, the safety device 100 may transmit the emergency alert to the remote system 804 via the network(s) 800. In an embodiment, the emergency alert may indicate the type of life-threatening event (e.g., electrocution), a location of the user 700, a time of the life-threatening event, the sensor data generated by the sensor(s) of the safety device 100 (e.g., the UV sensor 124), etc.

In an embodiment, the safety device 100 may communicate directly with the remote system 804 via the network(s) 800 and using one or more network interface(s). Additionally, or alternatively, in an embodiment, the safety device 100 may communicate with the remote system 804 via one or more intermediate devices, such as the equipment 808 and/or the user device 802 of the user 700. The user device 802 may include a mobile phone, smart watch, personal assistant, and the like. In an embodiment, the safety device 100 may transmit data to the user device 802 (e.g., via Bluetooth), and from there, the user device 802 may transmit the data to the remote system 804. Here, the user device 802 may act as an intermediary between the safety device 100 and the remote system 804. The user device 802 may also display the emergency alert on a display, or output other indications of the emergency alert (e.g., tactile, audible, etc.).

In a similar manner, the equipment 808 (e.g., machine, truck, etc.) may include computing components (e.g., network interfaces) for communicatively coupling with the network(s) 800. Here, the equipment 808 may additionally or alternatively act as an intermediary between the user device 802 and the remote system 804 for transmitting the emergency alert (or data associated therewith).

Upon receipt of the emergency alert, the remote system 804 may determine one or more responder(s) 810 to dispatch for responding to the user 700. The responder(s) 810 may be selected (e.g., chosen, determined, etc.) based upon a proximity of the responder(s) 810 to the user 700, preferences of the user 700 (e.g., in the event of the life-threating event), the type of life-threatening event detected, and the like. The responder(s) 810 may represent any personnel, such as a colleague, fellow worker, safety manager, foreman, friend, family, spouse, and the like. The responder(s) 810 may be located remote from the user 700 and/or within the same environment as the user 700 (e.g., worksite).

The remote system 804 communicates with the responder device 806 associated with the responder 810. In an embodiment, the responder device 806 may display information associated with the user 700, details of the life-threatening event, the location of the user 700, etc. Using the responder device 806, the responder 810 may communicate with the remote system 804, the user device 802, and/or the safety device 100, for example, confirming that the responder 810 is able to assist the user 700. The responder device 806 may represent any suitable device, such as a cell phone, tablet, laptop, desktop computer, etc. In an embodiment, the responder device 806 may represent the safety device 100 (e.g., a safety device 100 worn by the responder 810). Additionally, the responder device 806 need not include a display, but may include additionally or alternative output components (e.g., speaker(s)) to provide indications to the responder 810 as to the emergency alert.

In an embodiment, the remote system 804 may communicate with more than one responder 810 and more than one responder device 806. For example, the remote system 804 may determine a response team that includes multiple responders 810 (having respective responder devices 806) for responding to the emergency alert and providing assistance to the user 700. Furthermore, as will be discussed in detail herein, the remote system 804 may establish a communication platform (e.g., chatroom, messaging channel, communication channel, etc.) for the responder(s) 810 to communicate with one another, share information about the emergency alert (e.g., assistance provided), as well as to be updated of a current status of the user 700. For example, sensor data indicating whether the user 700 is motionless or moving (following the emergency alert) may be communicated to the responder(s) 810 within the platform.

Additionally, or alternatively, the responder device 806 or the remote system 804 may communicate with the equipment 808 used by the user 700. For example, when servicing overhead power lines, the user 700 may utilize a boom truck, scissor lift, etc. In an embodiment, when the user 700 experiences the life-threatening event while within, or otherwise using, the equipment 808, the remote system 804 and/or the responder device 806 may cause the equipment 808 to lower (or otherwise actuate). In an embodiment, the equipment 808 may be controlled by the safety device 100, the remote system 804, and/or the responder device 806 in response to the safety device 100 detecting a life-threatening event. In an embodiment, the equipment 808 may automatically lower based on the life-threatening event taking place. This may allow user 700 to be accessible by the responder(s) 810 when arriving on scene, prevent further injury to the user 700 (e.g., fall) after the life-threatening event, and/or reduce response times when tending to the user 700. In other embodiments, power systems may be controlled to terminate a supply of power and otherwise prevent further harm to the user 700.

Although the safety device 100 is shown communicatively coupled to certain systems, devices, equipment, the safety device 100 may additionally or alternatively communicatively couple to other systems, devices, equipment, and the like other than shown. For example, device(s) having sensor(s) may be disposed about a worksite of the user 700 for detecting the life-threatening event(s). In an embodiment, these device(s) may include sensor(s) mounted atop stands which image the worksite for detecting falls, arc-flashes, and the like. These device(s) may similarly communicate with the remote system 804 (or other device(s) on the network(s) 800) for detecting the life-threatening events.

In an embodiment, the remote system 804 includes, or is associated with, a dispatcher 812 that oversees, responds to, and/or coordinates a response to the emergency alert. For example, the dispatcher 812 may have access to information received by the remote system 804 for knowing the occurrence of the emergency alert. The dispatcher 812 may assist in dispatching the responder(s) 810 to the user 700. A dispatch device 814, for example, may display locations of the user 700 and/or the emergency alerts, statuses of the users 700 and/or the responder(s) 810 (e.g., busy, available, etc.), the type of life-threatening event, and the like. In this sense, the dispatcher 812 may continuously monitor the user 700, as well as other users, the status of the user 700, and help coordinate responses to the emergency alerts. In an embodiment, the dispatcher 812 may utilize the dispatch device 814 (e.g., mobile phone, laptop, desktop, etc.) for communicating with the safety device 100, the user device 802, the remote system 804, the responder device 806, and/or the equipment 808.

To communicate over the network(s) 800, and as indicated above, the safety device 100, the user device 802, the remote system 804, the responder device 806, the equipment 808, and the dispatch device 814 may include one or more network interface(s) (e.g., Wi-Fi, cellular, ZigBee, BLE, Bluetooth, Z-wave, etc.). The network(s) 800 may be representative of any type of communication network, including data and/or voice network, and may be implemented using wired infrastructure (e.g., cable, CAT5, fiber optic cable, etc.), a wireless infrastructure (e.g., RF, cellular, microwave, satellite, Bluetooth, etc.), and/or other connection technologies.

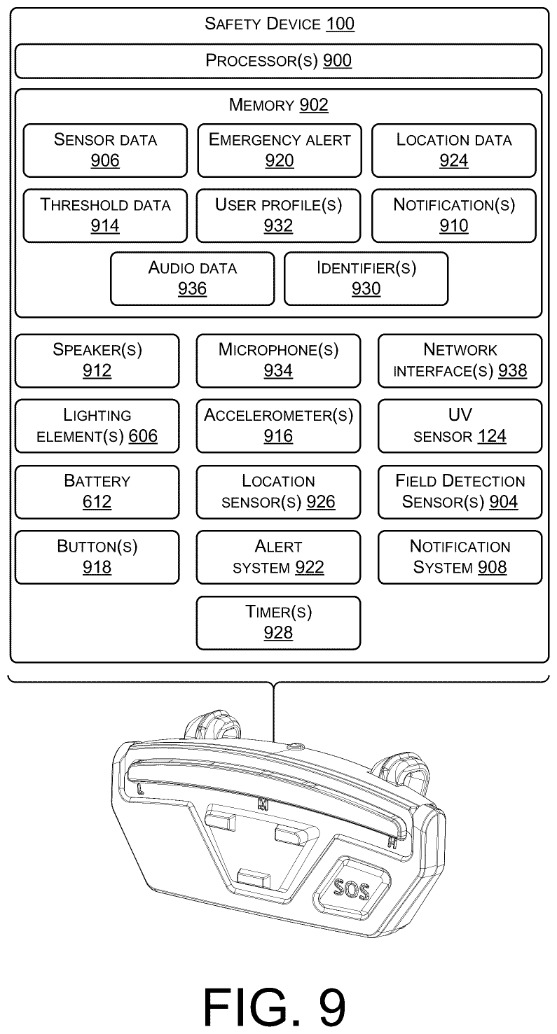

FIG. 9 illustrates example components of the safety device 100. The safety device 100 is shown including processor(s) 900 and memory 902, where the processor(s) 900 may perform various functions and operations associated with sensing conditions in proximity to the user 700, detecting life-threatening events, issuing emergency alerts, communicating with other device(s), and the like, while the memory 902 may store instructions executable by the processor(s) 900 to perform the operations described herein.

The safety device 100 includes one or more field detection sensor(s) 904 that are configured to detect a field signal that is at least one of an electric field signal or a magnetic field signal. For example, the field detection sensor(s) 904 may generate sensor data 906, such as a signal, that is passed to an amplifier configured to amplify the detected signal. The amplified signal may then pass to the processor(s) 900 that may process the amplified signal via an analog-to-digital converter (ADC). The converted digital signal may then be further processed via a digital filter. In an embodiment, the field detection sensor(s) 904 may include one or more capacitively coupled antennas to measure the electric field, one or more inductively coupled antennas to measure the magnetic field, or a magnetometer. Additional details of detecting and responding to electric field signal or a magnetic field signal are described in, for example, U.S. Pat. No. 11,009,532, which is herein incorporated by reference in its entirety and for all purposes.

The safety device 100 is shown including a notification system 908. The notification system 908 is configured to cause notifications 910 to be output on the safety device 100. For example, in response to the digital signal of the electric field signal or the magnetic field signal, the notification system 908 may cause the lighting element(s) 606 to illuminate to indicate a directionality and/or strength of the electric field signal or the magnetic field signal relative to the safety device 100. The notification system 908 may compare the signal to one or more threshold(s) to determine the relative strength of the electric field signal or the magnetic field signal. Additionally, in an embodiment, the notification system 908 may process the signal against historical measurements to determine the information associated with the electric field signal or the magnetic field, which in turn, may impact the notification(s) 910 output for indicating the directionality and/or strength of the electric field signal or the magnetic field. Inasmuch as energized conductors may emit an electric field due to the charge on the conductor, and a magnetic field due to current flowing through the conductor, the safety device 100 described herein may be configured to detect electric fields and/or magnetic fields. Using historical data of one or both of the detected fields, the safety device 100 may approximate the directionality of an energized conductor with respect to the position of the safety device 100.

Different notification(s) 910 may be output by the lighting element(s) 606 (e.g., color, blinking pattern, brightness, etc.) to indicate the directionality and/or strength of the electric field signal or the magnetic field signal. The lighting element(s) 606 are used to communicate information regarding a threat level, threat type (e.g., high voltage, high current, etc.), and location of the source to the user 700. More particularly, upon detection of an energized conductor, the notification system 908 may actuate one or more of the lighting element(s) 606 to orient the user 700 to the relative direction of the energized conductor. This may be achieved, for example, by illuminating a series of the lighting element(s) 606 at increasing levels of brightness sequentially disposed across the safety device 100 in the direction of the energized conductor, such that the brightest lighting element(s) 606 is located on the side of the safety device 100 corresponding to the direction of the energized conductor, illuminating one or more lighting element(s) 606 with gradually increasing brightness levels as a group, as the safety device 100 is oriented toward the direction of the energized conductor, illuminating a series of lighting element(s) 606, either fully on or intermittently fully on/off, in a sequence across the safety device 100 in the direction of the energized conductor, illuminating, either fully on or intermittently fully on/off, one or more lighting element(s) 606 disposed on a side of the safety device 100 corresponding to the relative direction of the energized conductor, or a combination of more than one of the aforementioned examples, etc. Further, as the safety device 100 moves with the user 700 in the direction indicated, the safety device 100 may alter the actuation of the lighting element(s) 606 when the safety device 100 is oriented in substantial alignment with the direction in which the peak of the electric and/or magnetic field is detected. An alteration of the actuation may include, for example, actions such as the safety device 100 may stop illuminating the series of LEDs sequentially, fully illuminate the lighting element(s) 606 simultaneously, slow the illumination sequence, stop illuminating the lighting element(s) 606 completely, etc.

It is noted that many, if not all, energized conductors may be dangerous depending on the circumstances. However, the risk of harm increases as the potential energy to be released increases (i.e., higher voltage relates to greater potential for serious physical harm), and as the amount of electrical energy in the proximity increases, the magnitude of the field signal to be detected likewise increases, thereby enabling the safety device 100 to detect high voltage carrying conductors at greater distances. Regardless, the safety device 100 may be configured to detect electric or magnetic fields having at least a minimum predetermined magnitude to thereby indicate that a greater risk of harm is possible. In an example, as the user 700 wearing the safety device 100 approaches a standard, properly-functioning electrical wall outlet, where the risk of harm is low for a user, the safety device 100 is not likely to initiate a warning unless the safety device 100 is placed at the height level of and within a few inches of the outlet.

Additionally, the notification(s) 910 instituted by the notification system 908 may include causing speaker(s) 912 to output audio (e.g., siren, tune, warning, etc.) indicative of the at least one of the electric field signal or the magnetic field signal. Still, the notification(s) 910 may include causing vibrational motor(s) of the safety device 100 to actuate to alert the user 700 of the electric field signal or the magnetic field. Regardless, the notification(s) 910 may serve as a notification to the user 700 to avoid a particular area within the environment, or to proceed within caution.

In an embodiment, the notification(s) 910 may be different depending upon the life-threatening event or the emergency alert being issued. For example, if the user 700 experienced a fall, a first audible tone or first light indication may be output. If the user 700 was shocked, a second audible tone, different than the first audible tone, or second light indication, different than the first audible tone, may be output. Still, even if life-threatening events are not detected, the safety device 100 may output the notification(s) 910 indicating detected electromagnetic fields, whether current and/or voltage. For example, if a voltage source is detected, first light indications (e.g., intensity, color, pattern, etc.) and/or first audible indications (e.g., volume, duration, pattern, etc.) may be output, which may be different than if a current source is detected, whereby second light indications (e.g., intensity, color, pattern, etc.) and/or second audible indications (e.g., volume, duration, pattern, etc.) may be output. If both current and voltage is detected, third light indications and/or third audible indications may be output.

The field detection sensor(s) 904 may also be used to determine whether the user 700 has experienced a life-threatening event (e.g., electrocution). In this sense, the safety device 100 may serve to proactively warn the user 700 in an attempt to avoid injuries, via the notification(s) 910, and may also be used to detect a life-threatening event. For example, the sensor data 906 generated by the field detection sensor(s) 904 (whether processed or unprocessed) may be compared against threshold data 914.

The threshold data 914 may be associated with detecting life-threatening event(s). For example, the field detection sensor(s) 904 may detect signals, as described above, indicative of a voltage or current sensed within a vicinity of the user 700 (or the safety device 100) or experienced by the user 700. The voltage or current detected by the field detection sensor(s) 904 may be used to determine whether the user 700 has been electrocuted or shocked. More particularly, the threshold data 914 may be associated with a threshold voltage and/or a threshold current that is indicative of the user 700 being electrocuted or shocked. If the sensor data 906 generated by the field detection sensor(s) 904 indicates a current or voltage that is greater than a threshold, the user 700 may have experienced electrocution or a shock. In such instances, the user 700 may have experienced a life-threatening event.

The safety device 100, additionally or alternatively, includes other sensor(s) for detecting the life-threatening events. For example, the UV sensor 124 may generate sensor data 906 that is used to determine whether an arc-flash occurred around the user 700. Here, the sensor data 906 from the UV sensor 124 may indicate a brightness of light, and this brightness may be compared against a threshold within the threshold data 914. The brightness may also be indicative of a relative proximity of the user 700 to the arc-flash. If the sensor data 906 does not satisfy the threshold data 914, this may indicate that an arc-flash did not occur or that the user 700 is at a far enough distance from the arc-flash (e.g., so as to not have experienced the life-threatening event). Comparatively, if the sensor data 906 satisfies the threshold data 914, an arc-flash may be determined to have occurred and that the user 700 may be in danger given the proximity of the arc-flash to the user 700.

In an embodiment, the UV sensor 124 includes, or is composed of, a life pipe and a lens to detect frontward facing arc-flashes (e.g., in front of the user 700). The light pipe and/or the lens combination is designed to maximize the viewing area for arc-flashes in proximity to the user 700. As such, this results in the area where arc-flash flashes are detected being a cone projected from the front 108 of the safety device 100, with a viewing angle of, for example, +/−45 degrees horizontally and/or +/−45 degrees vertically.

In an embodiment the UV sensor 124 is configured to detect certain wavelengths of light associated with arc-flashes. For example, in the event of an arc-flash, UV light in the spectrum of 300-400 nm is output. This UV output is due to the energy of the arc-flash ionizing nitrogen in the air. When nitrogen is ionized a UV frequency results from the reaction, creating UV light with the wavelength of 300-400 nm. In an embodiment, the UV sensor 124 may detect frequencies between 300 nm and 400 nm, to allow the safety device 100 to reliably detect the light resulting from an arc-flash (e.g., as compared to welding, UV light output by the sun, and so forth). In an embodiment, the UV sensor 124 may be a photodiode, phototransistor, or other light sensing component.

Still, the safety device 100 may include accelerometer(s) 916 that generates sensor data 906 indicate of whether the user 700 experienced a fall or was struck by objects (e.g., equipment). In a similar manner, if the sensor data 906 indicates that the user 700 experienced a fall of a certain magnitude, by comparing the sensor data 906 to the threshold data 914, the user 700 may have experienced a life-threatening event (e.g., fall). The accelerometer(s) 916 may generate sensor data 906 indicative of movement of the user 700, an acceleration, or change in acceleration experienced by the user 700, and so forth.

In an embodiment, the threshold(s) associated with the threshold data 914 may be determined via previous historical data. For example, accelerations or changes in acceleration during a fall may be used to determine the threshold(s) for whether the user 700 has fallen, experienced a shock, was in the proximity of an arc-flash, and so forth. In this sense, the historical data may be used to determine the threshold data 914 for knowing when the user 700 has experienced the life-threatening event. In a similar manner, voltage or current thresholds may be indicative of the user 700 being electrocuted.

Other sensor(s), however, may additionally or alternatively be used to detect the life-threatening events or otherwise determine a safety of the user 700. These sensor(s) may be included within the safety device 100 or may be separate from the safety device 100. In such embodiments, the sensor(s) may communicatively couple to the safety device 100 and/or the user device 802 for use in determining the life-threatening event. For example, if the user 700 is using a piece of equipment or is on ladder, a harness engagement sensor may be used to determine whether the user 700 is clipped in or harnessed to the equipment. As another example, sensor(s) may detect if a piece of equipment is too close to the user 700 and in response, may be disabled. As another example, a device (e.g., watch, band, etc.) may measure a heart rate of the user 700 for determining whether a life-threatening event occurred. Additionally, the safety device 100 may include a heat sensor to detect the arc-flashes in proximity to the user 700.

In an embodiment, multiple sensor(s), or multiple forms of the sensor data 906 generated by the sensor(s), respectively, may be used to determine whether a life-threatening event occurred. For example, the sensor data 906 generated by the field detection sensor(s) 904, the UV sensor 124, and/or the accelerometer(s) 916 may individually or collectively be used to determine whether a life-threatening event occurred. In this manner, the safety device 100 may introduce redundancy when determining the life-threatening event to be sure (e.g., high probability) that the user 700 experienced a life-threatening event. However, although certain forms of sensor data 906 are described as being used to determine a life-threatening event (e.g., voltage, current, acceleration, light, etc.), other forms of data may be used. Additionally, the safety device 100 may include other sensors not described for determining the occurrence of the life-threatening event. For example, as introduced above, heat sensor(s) (e.g., thermocouple, RTD, etc.) may measure heat within a proximity of the user 700 to determine whether an occurrence of an arc-flash. Still, motion sensor(s), microphone(s), etc. may be used to determine the occurrence of a life-threating event to sense a motion of the user 700 (e.g., after experiencing a shock) or sound generated from an arc-flash, fall, or impact, respectively.

The safety device 100 includes button(s) 918, such as the first button 118 and/or the second button 120. Pressing the second button 120, for example, may cause emergency alerts 920 to be issued. In this manner, the safety device 100 may automatically detect the life-threatening event via the field detection sensor(s) 904, the accelerometer(s) 916, the UV sensor 124, or other sensor(s) of the safety device 100, and may also include the second button 120 for allowing the user 700 to expressly indicate the life-threatening event. For example, the second button 120 may represent an S.O.S button that the user 700 may press to indicate the life-threatening event and accordingly, issue the emergency alert 920. The button(s) 918, whether the first button 118, the second button 120, or additional buttons may power on or off the safety device 100, mute the notifications 910, be used to check battery life status, adjust alert sensitivity, etc. In an embodiment, multiple functions may be accomplished, for example, by differing button hold-times, differing numbers of consecutive toggling, pressing on different sides/areas of the toggle, etc.

The button(s) 918 may also be used to pair the safety device 100 with the user device 802. For example, after pressing a button on the safety device 100, the safety device 100 may be moved into proximity to the user device 802, vice versa. During this process, the user device 802 and the safety device 100 may detect one another. This may pair the user device 802 and the safety device 100 one another, and/or configure setting(s) in the safety device 100 (e.g., responder(s) when responding to emergency alerts 920, the threshold(s) for determining the emergency alerts 920, and so forth).

The safety device 100 may include additional button(s) 918 that power the safety device 100 on and off, may include button(s) 918 for changing sensitivity setting(s) of the safety device 100, may include button(s) 918 for checking a battery life of the safety device 100, and so forth. In an embodiment, the safety device 100 may include button(s) that have a different functionality depending on how long the button is depressed. For example, holding a button down for a first time interval (e.g., one second) may power the safety device 100 on and off, while holding the same button down for a second time interval (e.g., two seconds), may change sensitivity setting(s) of the safety device 100 to detect voltage, current, falls, and so forth.

The safety device 100 is shown including an alert system 922 that issues the emergency alerts 920 in response to a determination that the user 700 experienced a life-threatening event. For example, in response to detecting a voltage and/or current greater than a threshold, the alert system 922 may determine to issue the emergency alert 920. Generally, the emergency alert 920 is a notification to provide support, assistance, or aid to the user 700. The emergency alert 920 may indicate the life-threatening event experienced by the user 700 as a way to indicate to the responders 810 that the user 700 has potentially been injured and is in need of assistance. As noted above, the emergency alert 920 may be sent to the remote system 804 whether directly or indirectly (via the user device 802).

In an embodiment, the safety device 100 or the remote system 804 may refrain from issuing the emergency alert 920 (e.g., to the responder device(s) 806, and the responder(s) 810) for a threshold period of time after detecting the life-threatening event. As an example, the safety device 100 may have incorrectly determined the life-threatening event, and prior to issuing the emergency alert 920, the user 700 may be provided an opportunity to cancel the emergency alert 920. In an embodiment, the user 700 may have dropped the safety device 100, and although the safety device 100 may have determined the life-threatening event (e.g., fall), the user 700 may not be in need of assistance. In another instance, the user 700 may have mistakenly pressed the second button 120.

In these, and other scenarios, the safety device 100 may output an indication that indicates the emergency alert 920 will be issued. For example, the indication may include audio output via the speaker(s) 912, a certain light display via the lighting element(s) 606, haptic feedback via the vibrational motors, and/or any combination thereof. In response, the user 700 may be provided a threshold period of time (e.g., 5 seconds, 10 seconds, 30 seconds, etc.) to cancel the emergency alert 920 being issued. In an embodiment, the user 700 may press the second button 120 to cancel issuing the emergency alert 920.

In addition to, or alternative from, the indication being output on the safety device 100, the user device 802 may output the indication. The user 700 may provide input to the safety device 100 and/or the user device 802 to cancel the emergency alert 920. However, in an embodiment, if the user 700 does not provide the input to cancel the emergency alert 920 within the threshold period of time, the emergency alert 920 may be sent to the remote system 804. The safety device 100 and/or the user device 802 may output a countdown timer as to when the emergency alert 920 will be issued if not canceled.

The emergency alert 920 sent to the remote system 804 may include the sensor data 906 associated with the detection of the life-threatening event. For example, the emergency alert 920 may include the sensor data 906 associated with the user 700 being electrocuted, falling, experiencing an arc-flash, and the like. In an embodiment, the emergency alert 920 may indicate that the user 700 pressed the second button 120 to issue the emergency alert 920. The emergency alert 920 may also indicate the type of life-threatening event experienced (e.g., fall, struck by, electrocution, etc.), in addition or alternative from, including the sensor data 906.

The emergency alert 920 may also include location data 924 generated by a location sensor(s) 926 of the safety device 100. The location data 924 may include a position of the user 700 (e.g., GPS coordinates) that is generated by the location sensor(s) 926. Including the location data 924 in the emergency alert 920 may provide the responder(s) 810 with the location of the user 700 to enable the responder(s) 810 to locate and travel to the user 700. The location of the user 700 may also be used to select those responder(s) 810 that are dispatched to respond to the user 700.

In an embodiment, the safety device 100 may not include the location sensor(s) 926, but the location of the safety device 100 (or the user 700) may be determined via the user device 802. For example, in response to a life-threatening event being detected, the user device 802 may receive an indication of such. To provide the responder(s) 810 with a known location of the user 700, the user device 802 may utilize location sensor(s) of the user device 802. That is, being as the safety device 100 may be paired with the user device 802, the location of the user device 802 may be used to provide the location of the user 700 to the responder(s) 810.

The emergency alert 920 may also indicate the time at which the life-threatening event was determined or when the emergency alert 920 was issued. For example, a timer 928 of the safety device 100 may record when the sensor data 906 was generated by the sensor(s), respectively. The timer 928 may also indicate the time for the user 700 to cancel the emergency alert 920.

The emergency alert 920 may also indicate an identifier 930 of the safety device 100 and/or the user 700. The identifier 930 may be used to associate the safety device 100 with the user 700 for determining who experienced the life-threatening event. For example, upon receipt of the identifier 930, the remote system 804 may determine who the safety device 100 is associated with, or who was using the safety device 100 at the time of the emergency alert 920.

Even after the safety device 100 issues the emergency alert 920, the safety device 100 may transmit the sensor data 906 to the remote system 804. For example, the sensor data 906 may be used to determine a status of the user 700. Sensor data 906 generated by the accelerometer(s) 916 may indicate whether the user 700 is moving, or whether the user 700 is motionless. The heart rate of the user 700, as captured by another device of the user 700 (e.g., the user device 802, a watch or wearable having a heart rate sensor, etc.), may able be sent to the remote system 804. Still the sensor data 906 may indicate whether the user 700 pressed the second button 120 to cancel the indication output on the safety device 100 (e.g., audio). This sensor data 906 may also be shared with the responder(s) 810 for informing the responder(s) 810 as to updates of the user 700 following the emergency alert 920 being issued. As such, even after the life-threatening event occurs, or the emergency alert 920 is issued, the safety device 100 may provide additional information to assess the condition of the user 700.

Although the emergency alert 920 is described as being transmitted to the remote system 804 after the predetermined amount of time, in an embodiment, the remote system 804 may be made aware of the emergency alert 920, but may not issue (e.g., broadcast) the emergency alert 920 to the one or more responders 810 until after the predetermined amount of time has lapsed without the emergency alert 920 being canceled. As such, in response to detecting the life-threatening event, the emergency alert 920 may be sent to the remote system 804, but the remote system 804 may not dispatch the one or more responder(s) 810 until the predetermined amount of time has elapsed without received an input to cancel the emergency alert 920. In this sense, the remote system 804 may be made aware of the life-threatening event and/or the emergency alert 920, but the issuance of that emergency alert 920 to the responder(s) 810 may not be sent until after the predetermined amount of time has elapsed.

The memory 902 is further shown storing user profile(s) 932, which may be used to determine the criteria when issuing the emergency alert 920. For example, the user profile(s) 932 may indicate the threshold data 914 that is used when determining whether the life-threatening event occurred. In this manner, the threshold data 914 may be customizable, for example, depending upon the experience, qualifications, certifications, and the like of the user 700. This allows the safety device 100 to be tailored to the user 700, by the user 700, and/or have different sensitivities or criteria for issuing the emergency alerts 920. The user profile(s) 932 may also include which forms of sensor data 906 are needed (e.g., required) to issue the emergency alert 920, or what types of life-threatening events that the safety device 100 is configured to respond to (e.g., arc-flash, electrocution, etc.). Still, the user profile(s) 932 may include the threshold period of time for allowing the user 700 to cancel the emergency alert 920 being issued. As such, the user profile(s) 932 allow the user 700, or a company of the user 700 (e.g., supervisor), to change the criteria for issuing the emergency alerts 920. In an embodiment, the criteria (or other setting(s)) of the safety device 100 may be configured using the safety device 100, the user device 802, or via the remote system 804.

The safety device 100 is further shown including microphone(s) 934 that generate audio data 936. The microphone(s) 934 may be used for capturing audio of the user 700 when communicating with the responder(s) 810 and/or the dispatcher 812, for example. In response to the emergency alert 920 being issued, the responders 810 and/or the dispatcher 812 may attempt to contact the user 700. Such audio is output via the speaker(s) 912, and the user 700 may respond via audio captured by the microphone(s) 934. This audio data 936 is then transmitted to the responder device 806, and/or the dispatch device 814, and/or the remote system 804 for output.

The microphone(s) 934 may also be used to detect falls, impacts, shocks, arc-flashes, and so forth. For example, sound associated with an arc-flash may be captured by the microphone(s) 934, and compared to thresholds to determine whether the sound is indicative of an arc-flash. In other embodiments, sound capture by the microphone(s) 934 may indicate whether the user 700 is producing sound following a life-threatening event. Still, in an embodiment, the microphone(s) 934 may be used to capture user commands (e.g., “Please send help”, “Emergency”, etc.) for use when determining the life-threatening event and/or when to issue the emergency alerts 920.

The safety device 100 includes network interface(s) 938 for communicating over the network(s) 800. The safety device 100 may include any number of network interface(s) 938 (e.g., Bluetooth, BLE, Wi-Fi, Cellular, Satellite, etc.) for communicating over the network(s) 800. A battery 612, or batteries, are shown for powering components of the safety device 100 (e.g., the processor(s) 900, sensor(s), etc.). The safety device 100 may include additional components, hardware, software, and the like other what those described herein. For example, the safety device 100 may include a battery indicator that indicates a battery life of the battery 612.

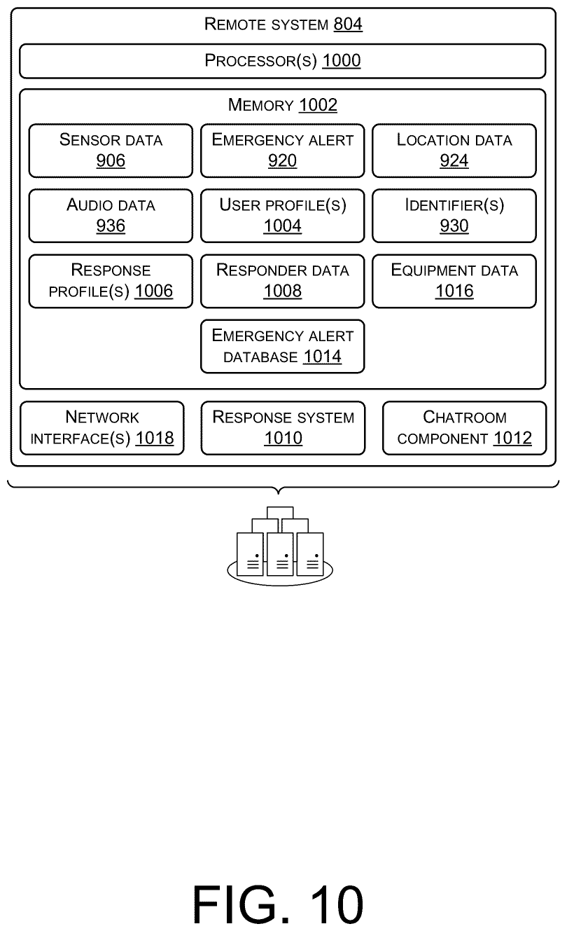

FIG. 10 illustrates example components of the remote system 804. The remote system 804 is shown including processor(s) 1000 and memory 1002, where the processor(s) 1000 may perform various functions and operations associated with issuing or otherwise responding to emergency alerts 920, while the memory 1002 may store instructions executable by the processor(s) 1000 to perform the operations described herein.

The remote system 804 communicatively couples to the safety device 100 and/or the user device 802 for receiving the sensor data 906, the emergency alert 920, and the location data 924, and/or other information. As indicated above, the emergency alert 920 (or data indicative of the emergency alert 920), may include the type of life-threatening event experienced by the user 700 (e.g., fall, struck by, electrocution, etc.), the time at which the life-threatening event was determined, the location of the user 700, the sensor data 906, and so forth. The emergency alert 920 may also indicate the identifier(s) 930 of the user 700 and/or the safety device 100 (or the user device 802). The identifier(s) 930 may be used for determining an identity of the user 700 or for determining additional information about the user 700 (e.g., medical history, allergies, emergency contacts, etc.). The emergency alert 920 is usable by the remote system 804 to determine the responders 810 for responding to the emergency alert 920.

The memory 1002 is also shown storing the user profiles 1004, which may be same as or different than the user profiles 932. For example, upon receipt of the emergency alert 920, the remote system 804 may glean additional information about the user 700 via accessing the user profiles 1004. The identifier(s) 930 in the emergency alert 920, for example, may be mapped to a user in the user profile(s) 1004. In an embodiment, the user profiles 1004 may include a list contacts that are to be contacted in the event of the emergency alert 920 being issued. The user profiles 1004 may also store phone numbers or other contact information that is readily available when the emergency alert 920 is issued.

The memory 1002 is also shown storing response profile(s) 1006. The response profile(s) 1006 may include information associated with responding to the emergency alert 920, such as how may responder(s) 810 to contact, experience or training of the responder(s) 810, a proximity of the responder(s) 810 to the user 700, emergency services to contact or dispatch, and so forth. For different types of life-threatening events or emergency alerts 920 issued, the response to the user 700 may be different, and the response may be determined at least in part via the user profile 1004 and/or the response profile 1006. Further, the response profile(s) 1006 may include templates for a predetermined response plan or procedure. Such procedures may be determined based at least in part on the type of the emergency alert 920. For example, if the type of emergency alert 920 indicates that the user 700 may have been electrocuted, one of the response procedures may be to shut down a power system in proximity to the user 700.

In an embodiment, the user profile(s) 1004 and/or the response profile(s) 1006 may be used to tailor or individually customize the responses to the emergency alert(s) 920. For example, the user 700 and/or the company of the user 700 may predetermine the response procedures when responding to the emergency alert 920, and the response procedures may be stored in the user profile(s) 1004 and/or the response profile(s) 1006. This permits different procedures to be implemented across life-threatening events, or across companies.

The audio data 936 stored in the memory 1002 may indicate audio generated by the microphone(s) 934 of the safety device 100. The audio data 936 may also include audio response(s) to the user 700, and which are output on the speaker(s) 912 of the safety device 100 for communicating with the user 700. The audio may additionally or alternatively be received from or output on the responder device 806. For example, the audio may include audio of the dispatcher 812 or the responder(s) 810 attempting to communicate with the user 700, or predetermined responses for assisting the user 700, such as whether help is on the way, advice to remain calm and breath, etc.

The remote system 804 also stores, or has access to, responder data 1008. The responder data 1008 may be associated with the responder(s) 810, or more generally, potential responders 810. For example, the responder(s) 810 may include family members, friends, co-workers, managers, emergency services, and the like. The responder(s) 810 may also be mapped to the user profile(s) 1004. In an embodiment, the responder(s) 810 are fellow workers of the user 700 that may have respective safety devices 100. The responder data 1008 may include identifier(s) 930 of the responder(s) 810 (e.g., name), contact information, role (e.g., foreman, supervisor, etc.), devices associated with the responder(s) 810, whether the responder(s) 810 have responded to previous emergency alert(s) 920, whether the responder(s) 810 are on a similar job as the user 700, a rating of the responder(s) 810, experience of the responder(s) 810, etc.

The responder data 1008 may also indicate a location of the responder(s) 810, for example, as received from location sensor(s) of the responder device(s) 806. In an embodiment, the location is continuously received from the responder(s) device(s) 806 for knowing a location of the responder(s) 810 (e.g., in proximity to the user 700), or in response to receiving the emergency alert 710, the responder device(s) 806 may be pinged to determine the location. The responder data 1008 is therefore usable by the remote system 804 when determining the responder(s) 810, such as how close the responder(s) 810 are to the user 700 when the emergency alert 920 is issued. For example, in an embodiment, responder(s) 810 that are located proximate (e.g., within a predetermined threshold distance, geofence around the user 700, etc.) may be selected for responding to the user 700 as compared to potential responder(s) 810 that are not located proximate to the user 700.

The remote system 804 is shown including a response system 1010 that determines the response to the emergency alert 920. For example, the response system 1010 may receive the emergency alert 920, process the emergency alert 920, and using the user profile(s) 1004, the response profile(s) 1006, the sensor data 906, determines how to respond to the emergency alert 920. In an embodiment, this includes transmitting the emergency alerts 920 to the responder(s) 810, respectively. For example, the remote system 804 may forward the emergency alert 920 to the responder(s) 810. In an embodiment, the emergency alerts 920 sent to the responder(s) 810 may be a request for the responder(s) 810 to travel to the user 700, to contact emergency services, to contact additional responder(s) 810 (e.g., other user(s) on site with the user 700), etc. In an embodiment, the emergency alert 920 sent to the responder(s) 810 includes the location of the user 700, the type of life-threatening event, the time at which the life-threatening event occurred, the sensor data 906, and the like.

The emergency alert 920 sent to the responder(s) 810 may be displayed on a display of the responder device 806. Additionally, or alternatively, the emergency alert 920 may cause the responder device to output audio (e.g., chime), illuminate (e.g., light(s)), vibrate, and the like. In other embodiments, the emergency alert 920 may be a call, text, or other message communicated to the responder(s) 810. The emergency alert 920 as output on the responder device(s) 806 may indicate the severity and emergency of the user 700.

As part of sending the emergency alert 920, the remote system 804 may establish a chatroom using a chatroom component 1012. The chatroom component 1012 may form a communication channel between the user 700, the responder(s) 810, and/or other individuals/personnel. Within the chatroom, the responder(s) 810, the user 700, the dispatcher 812, and/or other personnel may communicate about the emergency alert 920. The chatroom may centralize communications for keeping the responder(s) 810, the user 700, the dispatcher 812 up to date with current events associated with the emergency alert 920. For example, within the chatroom, the responder(s) 810 may share whether they have contacted the user 700. The chatroom may also include sensor data 906 generated by the sensor(s) (e.g., accelerometer(s) 916) that indicate whether the user 700 is motionless, for example. For example, following the life-threatening event, the chatroom may indicate whether motion of the safety device 100 was detected (e.g., motion of the user 700).

The remote system 804 may store the communications within the chatroom, as well as the emergency alerts 920, within an emergency alert database 1014. In general, the emergency alert database 1014 may store information associated with the emergency alerts 920, respectively, such as when the emergency alerts 920 occurred, what the responses were to the emergency alerts 920, the status of the emergency alerts 920 (e.g., pending, closed, etc.), who was involved (e.g., identity of the user 700, the responder(s) 810, etc.), the sensor data 906 generated or otherwise associated with detecting the emergency alert 920, exposure time, number of emergency alerts 920 (e.g., per user 700, per company, per environment, worksite, etc.), statistics, ratings, and the like. The emergency alert database 1014 may be accessed for determining information about the emergency alerts 920, which in an embodiment, may be used for training, auditing, or other purposes.

In an embodiment, the response system 1010 may automatically issue the emergency alert 920 and upon receiving the emergency alert 920 from the safety device 100. For example, the remote system 804 may continuously (e.g., according to a predetermined schedule) receive an indication (e.g., ping) from the safety device 100. The indication may indicate that the safety device 100 is still operational and in communication with the remote system 804. The indication may additionally, or alternatively, include the sensor data 906 which, for example, may be used to determine that the user 700 is moving. However, if the remote system 804 does not receive the indication, this may be indicative of the life-threatening event. For example, if the user 700 falls and the safety device 100 breaks (or is otherwise damaged), the safety device 100 may not have the ability to communicate the emergency alert 920 to the remote system 804. Instead, the remote system 804 may determine the occurrence of the life-threatening event if the remote system 804 does not receive the indication. In this embodiment, the remote system 804 may itself issue the emergency alert 920 in instances where the remote system 804 loses communication with the safety device 100 or does not receive an indication from the safety device 100 within a certain period of time.

As another example, in response to the user 700 being electrocuted, the components of the safety device 100 may be damaged (e.g., fried) and unable to communicate. Here to, if the remote system 804 does not receive the indication, the remote system 804 may determine the occurrence of the life-threatening event and issue the emergency alert 920. Although described as being performed by the remote system 804, the user device 802 may continuously monitor the safety device 100 and may itself issue the emergency alert 920 to the remote system 804 if the user device 802 loses communication with the safety device.

Additionally, or alternatively, in an embodiment, the remote system 804 may also receive sensor data 906 from the user device 802 to determine, or confirm, the detection of the life-threatening event. For example, the user device 802 may include the accelerometer 916, and the remote system 804 may receive sensor data 906 generated by the accelerometer 916 of the user device 802 when issuing the emergency alert 920 or determining the occurrence of the life-threatening event. For example, in an embodiment, the user device 802 may provide an indication of whether or not to issue the emergency alert 920, and the remote system 804 may either confirm or deny that the emergency alert 920 should be issued. The remote system 804, in another embodiment, may receive raw sensor data 906 from the user device 802 and determine whether to issue the emergency alert 920. In such examples, the user device 802 may transmit the sensor data 906, and the remote system 804 may determine whether the emergency alert 920 should be issued (as well as the responder(s) 810). However, any level or split processing may occur between the safety device 100, the user device 802, the remote system 804 (or other devices) to detect, respond to, or issue the emergency alerts 920.

The remote system 804 is further shown having access to, or storing, equipment data 1016. The equipment data 1016 may indicate pieces of machinery used by the user 700 or that are within an environment of the user 700. In an embodiment, the equipment data 1016 may be used to communicate with the equipment 808 for stopping an operation of the equipment (e.g., in response to the emergency alert 920) or to determine a status of the equipment (e.g., boom height, location, etc.).

The remote system 804 includes network interface(s) 1018 for communicating over the network(s) 800. The remote system 804 may include any number of network interface(s) 1018 (e.g., Wi-Fi, Cellular, etc.) for communicating over the network(s) 800.

The remote system 804 may be implemented as one or more servers and may, in an embodiment, form a portion of a network-accessible computing platform implemented as a computing infrastructure of processors, storage, software, data access, etc. that is maintained and accessible via a network such as the Internet. Common expressions associated with the remote system 804 include “on-demand computing”, “software as a service (SaaS)”, “platform computing”, “network-accessible platform”, “cloud services”, “data centers”, etc.

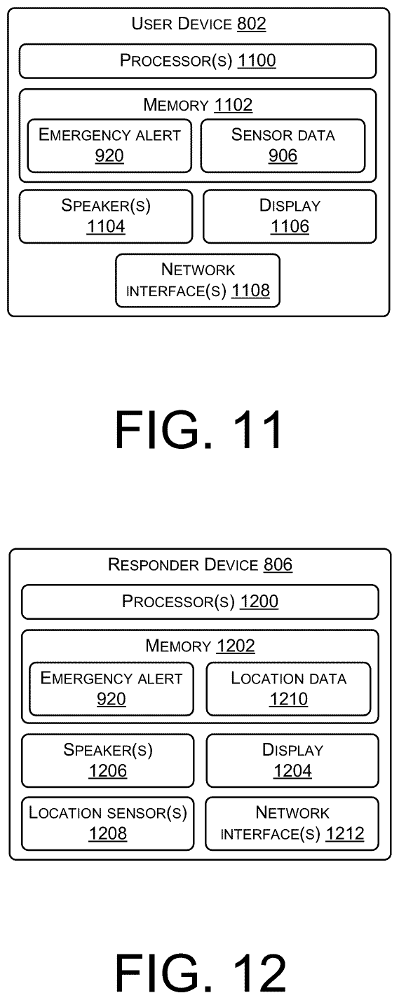

FIG. 11 illustrates select components of the user device 802. The user device 802 is shown including processor(s) 1100 and memory 1102, where the processor(s) 1100 may perform various functions and operations associated with communicating and/or responding to the emergency alerts 920, while the memory 1102 may store instructions executable by the processor(s) 1100 to perform the operations described herein.

For example, the user device 802 may send the emergency alert 920 to the remote system 804, and/or once the emergency alert 920 has been issued by the remote system 804, may also receive an indication of the emergency alert 920. The memory 1102 may also have access to, or store, the sensor data 906 generated by the sensor(s) of the safety device 100.

The user device 802 may include speaker(s) 1104 for outputting audio associated with the emergency alert 920, or for otherwise communicating when responding to the emergency alert 920. A display 1106 may present information associated with the emergency alert 920, such as an indication of the user 700, a location of the user 700, the type of emergency alert 920, what happened, who was involved, and the like. The user device 802 may also include network interface(s) 1108 for communicating with other devices on the network(s) 800.

As indicated above, the user device 802 may act as an intermediary between the safety device 100 and the remote system 804, as well as other devices on the network(s) 800. Additionally, using the user device 802, the user 700 may communicate with the other device(s) to indicate their status, need for assistance, and the like. For example, after the emergency alert 920 has been issued, and the user device 802 displays or outputs an indication of the emergency alert 920, the user 700 may communicate with the responder(s) 810 via the user device 802.

In an embodiment, the user 700 may also cancel the emergency alert 920 being issued using the user device 802. For example, before the user device 802 transmits (e.g., forwards) the emergency alert 920 to the remote system 804, the user device 802 may determine whether any input was received for cancelling the emergency alert 920, as well as whether the input was received within a threshold period of time since the life-threatening event occurred.

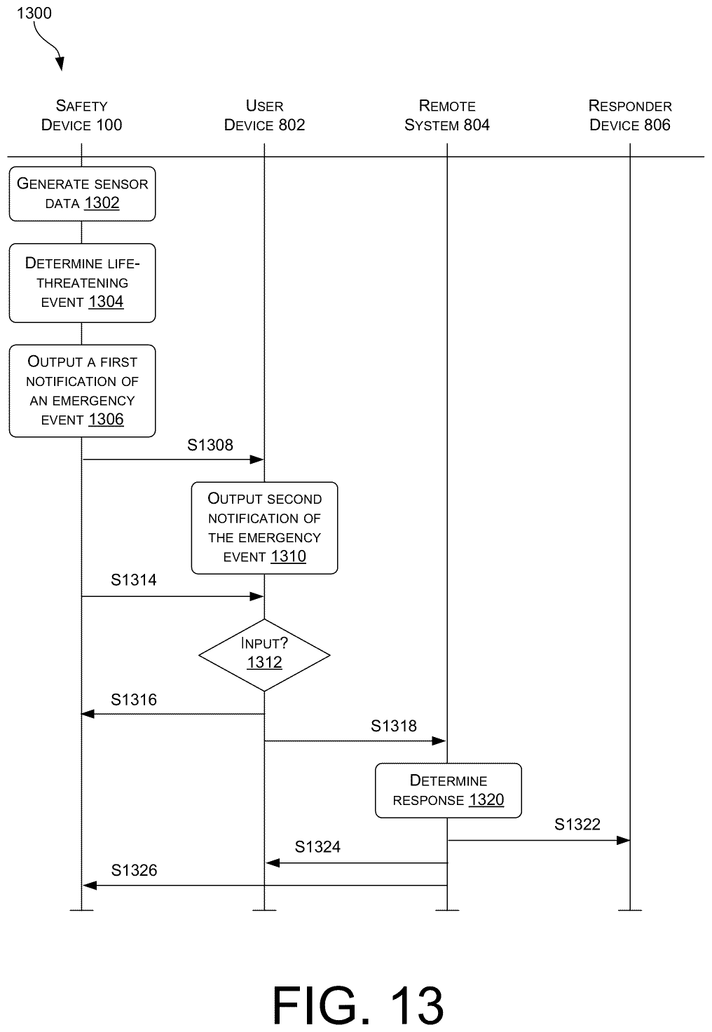

FIG. 12 illustrates select components of the responder device 806. The responder device 806 is shown including processor(s) 1200 and memory 1202, where the processor(s) 1200 may perform various functions and operations associated with responding to the emergency alerts 920, while the memory 1202 may store instructions executable by the processor(s) 1200 to perform the operations described herein.

For example, the responder device 806 may receive an indication of the emergency alert 920 from the remote system 804. The emergency alert 920 may include an identification of the user 700, a location of the user 700, the type of emergency alert 920, what happened, who was involved, and the like. In an embodiment, the responder device 806 includes a display 1204 and/or speaker(s) 1206 for outputting information associated with the emergency alert 920. Using the responder device 806, the responder 810 may communicate with other responder(s) 810, the user 700, the dispatcher 812, or other personnel (e.g., emergency services) for assisting in the emergency alert 920.

The responder device 806 also includes a location sensor 1208, which generates location data 1210, for knowing the location of the responder(s) 810, which may be useful by the remote system 804 when selecting those responder(s) 810 to respond to the emergency alert 920 (e.g., closest). However, some of the responder(s) 810 may be fellow workers who have a safety device, and the location of those responder(s) 810 may be determined via the safety device, respectively.

The responder device 806 may also include network interface(s) 1212 for communicating with other devices on the network(s) 800.

As used herein, a processor, such as the processor(s) 900, the processor(s) 1000, the processor(s) 1100, and/or the processor(s) 1200 may include multiple processors and/or a processor having multiple cores. Further, the processor(s) may comprise one or more cores of different types. For example, the processor(s) may include application processor units, graphic processing units, and so forth. In one implementation, the processor(s) may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

Memory, such as the memory 902, the memory 1002, the memory 1102, and/or the memory 1202 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s). In an embodiment, the memory 902, the memory 1002, the memory 1102, and/or the memory 1202 may represent one or more non-transitory computer-readable media storing instructions that, when executed by the processor(s) 900, the processor(s) 1000, the processor(s) 1100, and/or the processor(s) 1200, respectively cause the processor(s) 900, the processor(s) 1000, the processor(s) 1100, and/or the processor(s) 1200, respectively to perform recited operations.

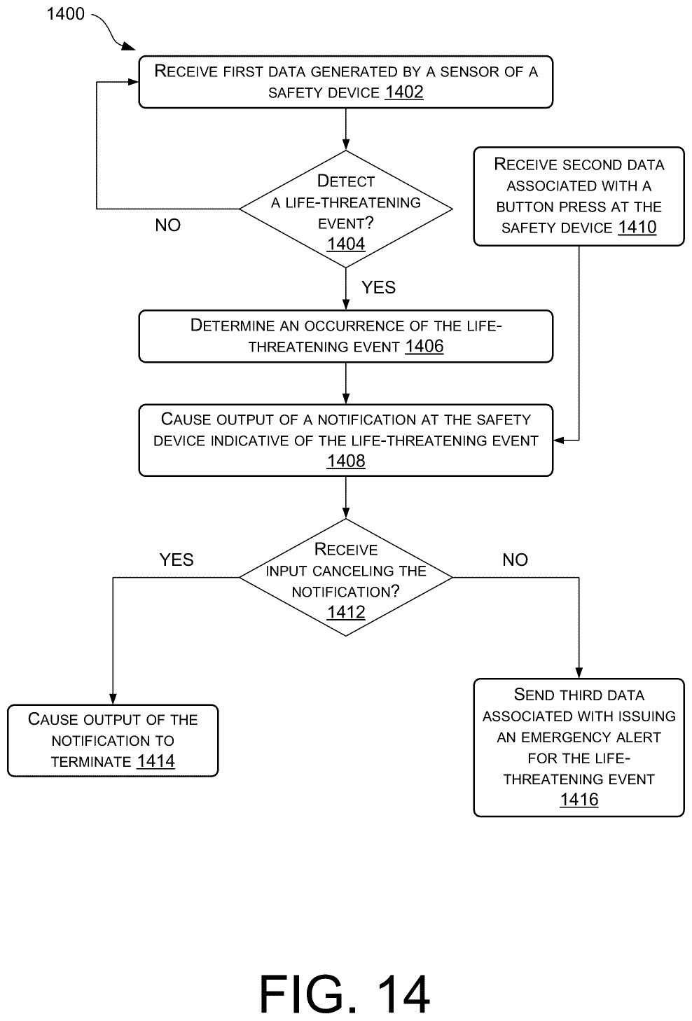

FIG. 13 illustrates a signal diagram 1300 showing signals transmitted between the safety device 100, the user device 802, the remote system 804, and the responder device 806. The signals may be generated depending on results determined in intermediate process steps.

At step 1302, the safety device 100 may generate sensor data 906. The sensor data 906 may be generated by the UV sensor 124, the accelerometer(s) 916, the field detection sensor(s) 904, and/or other sensor(s) (e.g., motion sensor, accelerometer, temperature sensor, etc.) of the safety device 100 for detecting life-threatening event(s) experienced by the user 700.

At step 1304, the safety device 100 may determine a life-threatening event based at least in part on the sensor data 906. For example, the sensor data 906 may be compared to one or more threshold(s) that are indicative of the user 700 experiencing a life-threatening event (e.g., electrocution, fall, impact, arc-flash, etc.). Such threshold(s) may be previously determined (e.g., via historical data) and be associated with the user 700 experiencing a life-threatening event (e.g., training data). The threshold(s) may be stored on the memory 902 of the safety device 100 such that the safety device 100 may compare the compare the sensor data 906 to the threshold(s) in real time for determining the life-threatening events.

At step 1306, the safety device 100 may output a first notification of an emergency alert. For example, the safety device 100 may output notification(s) 910 via the lighting element(s) 606, the speaker(s) 912, vibrational motors, and the like. In an embodiment, the emergency alert 920 may not be sent to the remote system 804, but rather, the safety device 100 may warn the user 700 of the pending emergency alert 920. Alternatively, in an embodiment, the emergency alert 920 may be sent to the remote system 804, while still allowing the user 700 to cancel the emergency alert 920 (e.g., within the predetermined amount of time).

The safety device 100 may transmit a signal S1308 to the user device 802. The signal S1308 may include the emergency alert 920, the type of emergency alert 920, the sensor data 906, the location data 924, and the like. In an embodiment, the signal S1308 may be sent via Bluetooth or BLE. In response, at step 1310, the user device 802 may output a second notification of the emergency alert 920. For example, the user device 802 may output notification(s) 910 via the display 1106, the speaker(s) 1104, the vibrational motors, and the like warning of the emergency alert 920. As such, both the safety device 100 and the user device 802 may output notification(s) 910 of the emergency alert 920. In an embodiment, the safety device 100 and/or the user device 802 may provide the emergency alert to the remote system 804.

At step 1312, the user device 802 may determine whether any input was received associated with cancelling the emergency alert 920. For example, even though the safety device 100 detected the life-threatening event, the user 700 may not be in need of assistance and may provide input to cancel the notification. In an embodiment, the input is received via the second button 120. In another example, the user 700 may have mistakenly issued the emergency alert 920 (e.g., via pressing the second button 120), and may want to cancel the emergency alert 920. In such embodiment, the user 700 may press the second button 120. In an embodiment, the input may be received via the safety device 100 or via the user device 802.

In an embodiment, the user device 802 may determine whether the input is received within a threshold period of time (e.g., 10 seconds). The input may be received at the user device 802 (e.g., via a touch-screen display that displays the emergency alert 920), and/or via a signal S1314 from the safety device 100 (e.g., button press). If the input is received, the user device 802 may terminate output of the second notification, and may transmit a signal S1316 to the safety device 100 to terminate output of the first notification. In other embodiments, the safety device 100 may terminate output of the first notification on its own if the input is received (e.g., via the second button 120).

If no input is received (e.g., within the threshold period of time), the user device 802 may transmit a signal S1318 to the remote system 804 indicative of the emergency alert 920. The signal S1318 may include information associated with the emergency alert 920, such as the time at which the life-threatening event was detected, an identifier of the user 700 (e.g., name), a location of the user 700, a type of life-threatening event detected, and/or other information associated with the life-threatening event. Such information is used when sending the emergency alert 920 to the responder(s) 810 for informing the responder(s) 810 as to the life-threatening event of the user 700. However, in an embodiment, the safety device 100 may transmit the emergency alert 920 directly to the remote system 804.

At step 1320, the remote system 804 may determine a response to the emergency alert 920. For example, the remote system 804 may determine the responder(s) 810 based on the user profile(s) 1004 and/or the response profile(s) 1006. Upon determining the response, the remote system 804 may transmit a signal S1322 to the responder device 806 informing the responder(s) 810 of the emergency alert 920. The signals S1322 may be sent to respective responder devices 806 of the responder(s) 810. In an embodiment, the signal S1322 may include the time at which the life-threatening event was detected, an identifier of the user 700 (e.g., name), a location of the user 700, a type of life-threatening event detected, and/or other information associated with the life-threatening event.

Additionally, the remote system 804 may transmit a signal S1324 and/or a signal S1326 to the user device 802 and the safety device 100, respectively. The signal S1324 and/or the signal S1326 may include similar information as the signal S1322. The signal S1324 and the signal S1326 may inform the user 700 that the emergency alert 920 was issued to the responder(s) 810, and serve as a confirmation that the emergency alert 920 was received and help is on the way.

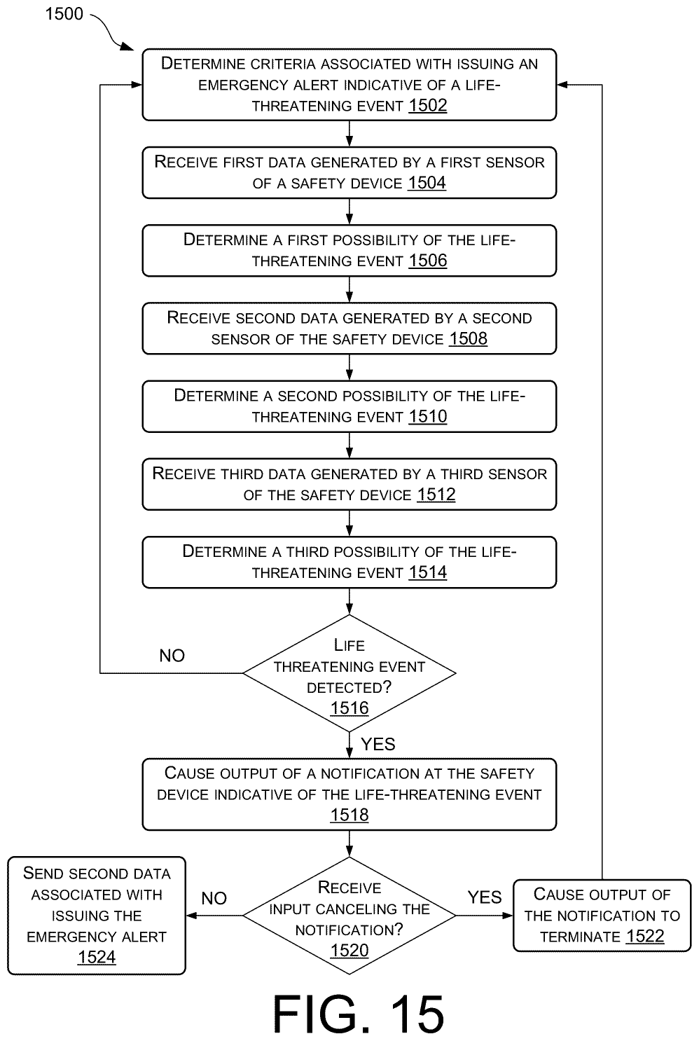

FIGS. 14-18 illustrate various processes related to detecting and issuing emergency alerts. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures, devices, and systems described in the examples herein, such as, for example those described with respect to FIGS. 1-13, although the processes may be implemented in a wide variety of other environments, architectures, devices, and systems.

FIG. 14 illustrates an example process 1400 associated with the safety device 100 determining a life-threatening event and whether to issue an emergency alert 920.

At step 1402, the process 1400 may include receiving first data generated by a sensor of a safety device. For example, the safety device 100 or components thereof (e.g., the processor(s) 900, the alert system 922, the notification system 908, etc.) may receive sensor data 906 generated by one or more sensors of the safety device 100, such as the accelerometer(s) 916, the field detection sensor(s) 904, the UV sensor 124, and so forth. In an embodiment, the sensor data 906 may be received on predetermined intervals (e.g., every 100 milliseconds, every second, etc.).

At step 1404, the process 1400 may include determining whether a life-threatening event was detected. For example, the sensor data 906 may be analyzed to determine whether the sensor data 906 is indicative of the life-threatening event. In an embodiment, this may include comparing the sensor data 906 to one or more threshold(s). For example, if the sensor data 906 is generated by the accelerometer 916, the process 1400 may determine whether the detected acceleration is greater than a threshold acceleration. If the sensor data 906 is generated by the field detection sensor(s) 904, the process 1400 may determine whether a detected current is greater than a threshold current and/or whether a voltage is greater than a threshold voltage. The field detection sensor(s) 904 may also be used to measure a strength of magnetic field and/or electric fields in proximity to the user 700. If the sensor data 906 is generated by the UV sensor 124, the process 1400 may determine whether the detected light (e.g., arc-flash) is greater than a threshold amount of light. The sensor data 906 may therefore be used to determine whether the user 700 has experienced a life-threatening event by comparing the sensed conditions to respective thresholds.

In an embodiment, sensor data 906 from multiple sensor(s) may be used for determining the occurrence of the life-threatening event. For example, sensor data 906 from one sensor (e.g., the UV sensor 124) may be used to determine the life-threatening event, or sensor data from multiple sensors (e.g., the UV sensor 124 and the accelerometer(s) 916) may be used to the determine the life-threatening event. In an embodiment, the user profile(s) 932 may be used to indicate which sensor data 906 is used to determine the life-threatening event, the threshold(s) to which to compare the sensor data 906, weights to apply to the sensor data 906, etc. As such, multiple forms of sensor data 906 may be compared against respective thresholds to determine whether the life-threatening event was detected.

In an embodiment, as a result of detecting the life-threatening event, the safety device 100 may transition from a first power mode to a second power mode. For example, the safety device 100 may be configured to operate between different power modes in order to conserve a battery life of the battery 612. For example, when the safety device 100 is monitoring for life-threatening events, the safety device 100 may be in a low-power mode (e.g., to power the sensor(s)). However, if and when the safety device 100 detects the life-threatening event, the safety device 100 may switch into a high-power mode in which increased power is demanded. This increase power demand may be used to power network interface(s), the location sensor, and so forth of the safety device 100 in order to communicate with the other device(s), such as the user device 802, and provide the location of the user 700.

If at step 1404 the process 1400 determines that the life-threatening event was not detected, the process 1400 may follow the “NO” route and loop to step 1402. Here, the sensor(s) of the safety device 100 may continue to generate the sensor data 906 for determining whether the user 700 experienced a life-threatening event. Alternatively, if at step 1404, the process 1400 determines that the life-threatening event was detected, the process 1400 may follow the “YES” round and proceed to step 1406.

At step 1406, the process 1400 may include determining an occurrence of a life-threatening event. For example, if the sensor data 906 indicates that the user 700 fell, an arc-flash occurred within a vicinity of the user 700, the user 700 was electrocuted, and the like, the safety device 100 may determine that the user 700 experienced a life-threatening event (or that a life-threatening event occurred).

At step 1408, the process 1400 may include causing output of a notification at the safety device indicative of the life-threatening event. For example, the safety device 100 may output audio (e.g., alarm, siren, beeps, etc.), illuminate the lighting element(s) 606 to a certain color, intensity, pattern, etc., vibrate, and the like. These notifications may serve to get the attention of the user 700 and/or indicate to the user 700 of the occurrence of the life-threatening event. Additionally, or alternatively, in an embodiment, the safety device 100 may also transmit a notification of the life-threatening event to the user device 802 and/or the remote system 804. In response, the user device 802 may display an indication of the life-threatening event, and/or the remote system 804 may be made aware of the emergency alert 920.

As also shown, the process 1400, at step 1410, may include receiving second data associated with a button press at the safety device. For example, the user 700 may press the second button 120 to indicate the life-threatening event. In response to receiving the second data, the process 1400 may continue to step 1408 to cause output of the notification. As such, the notification may be initiated via an autonomous detection of the life-threatening event (e.g., via the sensors of the safety device 100) and/or via an express indication provided by the user 700 (e.g., via the second button 120).

At step 1412, the process 1400 may include determining whether input is received associated with cancelling the notification. For example, the safety device 100 may have improperly detected the life-threatening event and the user 700 may be OK (e.g., not in need of assistance and/or may not have experienced a life-threating event). The user 700, for example, may have dropped the safety device 100. Here, the safety device 100 may have detected the life-threatening event, but the user 700 may not be in need of assistance and may provide input to cancel the notification. In an embodiment, the input is received via the second button 120. Alternatively, the input may be received at the safety device 100 from the user device 802. In an embodiment, the process 1400 may determine whether the input is received within a threshold period of time (e.g., 10 seconds) since detecting the life-threatening event or outputting the first notification. In another example, the user 700 may have mistakenly issued the life-threatening event (e.g., via pressing the second button 120), and may want to cancel the life-threatening event. In such embodiment, the user 700 may press the second button 120 (for a threshold period of time) to cancel the notification and/or the issuance of the emergency alert 920.

If at step 1412 the process 1400 determines that the input is received, the process 1400 may follow the “YES” route and proceed to step 1414. For example, the user 700 may press the second button 120 to cancel the life-threatening event. In response, the safety device 100 may cause output of the notification (at step 1408) to terminate. Thus, the process 1400 may loop to 1402 whereby the safety device 100 may continue to receive the sensor data 906 for detecting life-threatening events. Alternatively, if at step 1412 the process 1400 determines that the input is not received, the process 1400 may follow the “NO” route and proceed to step 1416.

At step 1416, the process 1400 may include sending third data associated with issuing an emergency alert for the life-threatening event. For example, the safety device 100 may transmit the third data to the user device 802 (for forwarding to the remote system 804) or the safety device 100 may transmit the third data directly to the remote system 804. In an embodiment, the third data may indicate the life-threatening event (e.g., arc-flash, fall, etc.), a time at which the life-threatening event was detected, a location of the user 700, an identifier of the user 700 (e.g., name, role, etc.), and the like. However, other information associated with the user 700, the life-threatening event, or data generated by other sensor(s) of the safety device 100. In response to receiving the third data, the remote system 804 may cause the emergency alert 920 to be issued to the responders 810.

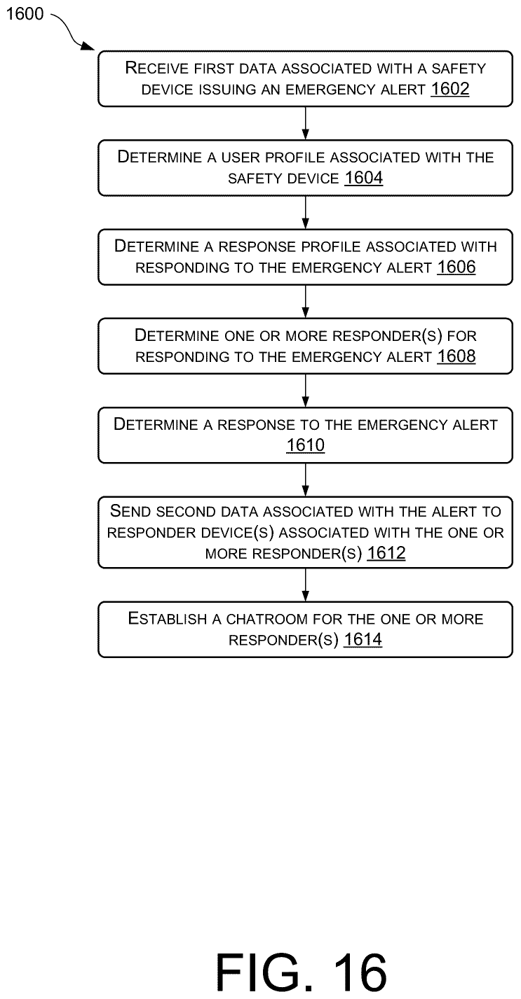

FIG. 15 illustrates an example process 1500 associated with the safety device 100 determining a life-threatening event and whether to issue an emergency alert 920.

At step 1502, the process 1500 may include determining criteria associated with issuing an emergency alert indicative of a life-threatening event. For example, the users 700 may customize the criteria (e.g., thresholds, characteristic(s), standard(s), setting(s) etc.) associated with issuing the emergency alerts 920. In this sense, the criteria by which the emergency alerts 920 are issued may be predetermined by the user 700, a historical use or conditions of the user 700, a company of the user 700, local and/or state regulations, an experience of the user 700, a location of the user 700, and the like. The criteria may indicate respective thresholds that need to be satisfied (e.g., voltage, current, acceleration, brightness, etc.) before issuing the emergency alert 920. In turn, the criteria is used when determining whether to issue the emergency alerts 920. In an embodiment, the criteria may be received via the safety device 100, the user device 802 (e.g., interacting with a mobile application) and then provided to the safety device 100, and/or the remote system 804.

At step 1504, the process 1500 may include receiving first data generated by a first sensor of a safety device. For example, the first sensor may include the field detection sensor(s) 904, and the first data may include sensor data 906 generated by the field detection sensor(s) 904. At step 1506, the process 1500 may include determining a first possibility of the life-threatening event. The first possibility may be based at least in part on the first data generated by the field detection sensor(s) 904. For example, the first possibility may be determined by comparing the first data to a threshold, to determine whether the voltage, current, etc. detected by the field detection sensor(s) 904 is greater than or less than the threshold. The threshold may be determined as a threshold amount of voltage or current associated with an electrocution, or an amount of voltage or current that would be life-threatening to the user 700.

At step 1508, the process 1500 may include receiving second data generated by a second sensor of a safety device. For example, the second sensor may include the UV sensor 124, and the second data may include sensor data 906 generated by the UV sensor 124. At step 1510, the process 1500 may include determining a second possibility of the life-threatening event. The second possibility may be based at least in part on the second data generated by the UV sensor 124. For example, the second possibility may be determined by comparing the second data to a threshold, to determine whether the light intensity detected by the UV sensor 124 is greater than or less than the threshold. The threshold may be determined as a threshold amount of light associated with an arc-flash within a certain distance of the user 700.

At step 1512, the process 1500 may include receiving third data generated by a third sensor of the safety device. For example, the third sensor may include the accelerometer 916, and the third data may include sensor data 906 generated by the accelerometer 916. At step 1514, the process 1500 may include determining a third possibility of the life-threatening event. The third possibility may be based at least in part on the third data generated by the accelerometer 916. For example, the third possibility may be determined by comparing the third data to a threshold, to determine whether the acceleration is greater than or less than the threshold. The threshold may be determined as a threshold acceleration associated with a fall, or a fall that would be life-threatening to the user 700.

At step 1516, the process 1500 may include determining whether the life-threating event was detected. For example, the safety device 100 may determine whether the life-threating event was detected based at least in part on the first possibility, the second possibility, and/or the third possibility. In an embodiment, the safety device 100 may draw correlations between the first data, the second data, and the third data, and/or the first possibility, the second possibility, and/or the third possibility to determine whether the life-threating event was detected. For example, the first data may be indicative of the user 700 being electrocuted, the second data may be indicative of an arc-flash occurring, and the third data may be indicative of the user 700 falling (e.g., after being electrocuted). This timeline of events may indicate that the user 700 fell to the ground after being electrocuted, and as such, the process 1500 may determine the occurrence of the life-threatening event.

Using the first data, the second data, and the third data, and/or the first possibility, the second possibility, and/or the third possibility may reduce false positives when issuing the emergency alerts 920. That is, data from multiple sensor(s) may be used to redundantly determine whether a life-threatening event occurred. In an embodiment, different weights may be applied to the first data, the second data, and the third data, and/or the first possibility, the second possibility, and/or the third possibility based on the type of sensor data 906, the time at which the sensor data 906 was generated, and the like. Additionally, although the process 1500 illustrates using three forms of data to determine whether the life-threatening event occurred, more or less forms of data may be used. For example, the safety device 100 may only use the accelerometer 916 and the UV sensor 124 to detect the life-threatening event. Additionally, audio data 936 generated by the microphone(s) 934 may indicate sound generated in proximity to the user 700 that may be indicative of arc-flashes, impacts, falls, and so forth. Such criteria may be determined, or programmed into the safety device 100, at step 1502.

If at step 1516 the process 1500 determines that the life-threatening event was not detected, the process 1500 may follow the “NO” route and loop to step 1502. Alternatively, if the process 1500 determines that the life-threatening event was detected, the process 1500 may follow the “YES” route and proceed to step 1518.

At step 1518, the process 1500 may include causing output of a notification at the safety device indicative of the life-threatening event. For example, the safety device 100 may output audio (e.g., alarm, siren, beeps, etc.), illuminate the lighting element(s) 606 to a certain color, intensity, pattern, etc., vibrate, and the like. These notification(s) 910 may serve to get the attention of the user 700 and/or indicate to the user 700 of the occurrence of the life-threatening event. Additionally, or alternatively, in an embodiment, the safety device 100 may also transmit a notification of the life-threatening event to the user device 802 and/or the remote system 804. In response, the user device 802 may display an indication of the life-threatening event.

At step 1520, the process 1500 may include determining whether input is received associated with cancelling the notification. For example, the safety device 100 may have improperly detected the life-threatening event. The user 700, for example, may have dropped the safety device 100. In an embodiment, the input is received via the second button 120, voice commands provided to the microphone(s) 934, input at the user device 802, and so forth. The user 700 may also have mistakenly issued the life-threatening event (e.g., via pressing the second button 120), and may want to cancel issuing of the emergency alert 920. The input may be received at the safety device 100 from the user device 802. In an embodiment, the process 1500 may determine whether the input is received within a threshold period of time (e.g., 10 seconds, one minute, etc.) before concluding that the input as or was not received.

If at step 1520 the process 1500 determines that the input is received, the process 1500 may follow the “YES” route and proceed to step 1522. For example, the user 700 may press the second button 120. In response, the safety device 100 may cause output of the notification (at step 1520) to terminate. From step 1522, the process 1500 may loop to step 1502 to continue monitoring for life-threatening events. Alternatively, if at 1520 the process 1500 determines that the input is not received, the process 1500 may follow the “NO” route and proceed to step 1524.

At step 1524, the process 1500 may include sending second data associated with issuing an emergency alert for the life-threatening event. For example, the safety device 100 may transmit the second data to the user device 802 (for forwarding to the remote system 804) or the safety device 100 may transmit the third data to the remote system 804. In an embodiment, the second data may indicate the life-threatening event (e.g., arc-flash, fall, etc.), a time at which the life-threatening event was detected, a location of the user 700, an identifier of the user 700 (e.g., name, role, etc.), and the like.

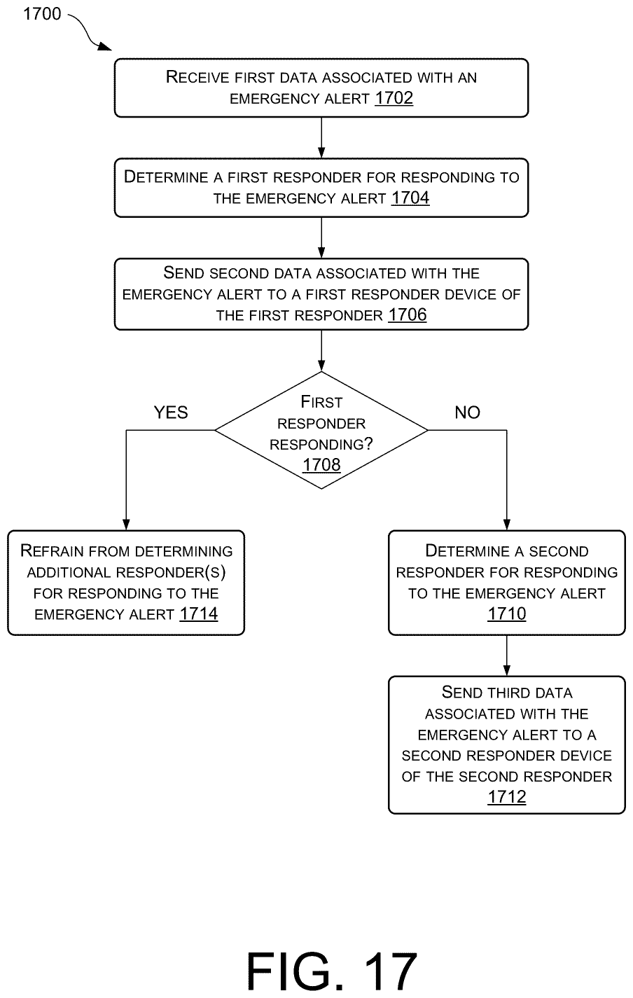

FIG. 16 illustrates an example process 1600 associated with the remote system 804 determining the responders 810 and responding to the emergency alert 920.

At step 1602, the process 1600 may include receiving first data associated with a safety device issuing an emergency alert. For example, the remote system 804 may receive first data associated with the safety device 100 detecting a life-threatening event (e.g., arc-flash, electrocution, fall, etc.). In an embodiment, the first data may include the time at which the life-threatening event was detected, an identifier of the user 700 (e.g., name), a location of the user 700, a type of life-threatening event detected, and/or other information associated with the life-threatening event. In an embodiment, the remote system 804 may receive the first data from the safety device 100 directly, or indirectly (e.g., via the user device 802).

At step 1604, the process 1600 may include determining a user profile associated with the safety device. For example, using an identifier of the safety device 100 or an identifier of the user 700 (e.g., via the first data), the process 1600 may determine the user profile 1004. In an embodiment, the user profile 1004 may indicate specifics of the user 700 (e.g., age, allergies, medical history, etc.) for knowing additional information of the user 700 not included in the first data. Additionally, the user profile 1004 may indicate the responder(s) 810 to contact when the emergency alert 920 is issued. In this manner, how the remote system 804 responds to the emergency alerts 920 may be based on preferences of the user 700. The user profile 1004 may also be associated with a company of the user 700, and the company may have criteria for responding to the emergency alerts 920.

At step 1606, the process 1600 may include determining a response profile associated with responding to the emergency alert. For example, based on the type of life-threatening event, the remote system 804 may determine how to respond to the user 700. The response profile 1006 may include information associated with how many responder(s) 810 to contact, experience or training of the responder(s) 810, a predetermined proximity of the responder(s) 810 to the user 700, emergency services to contact or dispatch, and the like. For different types of life-threatening events, the response to the user 700 may be different, and the response may be determined at least in part via the user profile 1004 and/or the response profile 1006.

At step 1608, the process 1600 may include determining one or more responder(s) for responding to the emergency alert. For example, the remote system 804, using the user profile 1004 and/or the response profile 1006, may determine the responder(s) 810 to contact for responding to the user 700, as well as a number of responder(s) 810 to contact. In an embodiment, the responder(s) 810 may be selected based on their proximity to the user 700, or the amount of time the responder 810 will take to travel to the user 700.

At step 1610, the process 1600 may include determining a response to the emergency alert. For example, the response may request the responder(s) 810 to travel to the user 700, for the responder(s) 810 to contact emergency services, for the responder(s) 810 to contact other responder(s) 810, and the like. The response may therefore represent a request for the responder 810 for responding the emergency alert 920.

At step 1612, the process 1600 may include sending second data associated with the emergency alert to the responder device(s) of the responder(s). For example, the remote system 804 may transmit the second data to the responder device(s) 806 that are associated with the responder(s) 810. The second data may include a request for traveling to the user 700 and providing assistance. In an embodiment, the second data may include the time at which the life-threatening event was detected, an identifier of the user 700 (e.g., name), a location of the user 700, a type of life-threatening event detected, and/or other information associated with the life-threatening event (e.g., sensor data generated via the sensor(s) of the safety device 100).

The second data may also indicate a checklist to complete when arriving on scene and providing assistance to the user 700, such as a checklist to diagnose symptoms of the user 700. This may be useful in requesting additional responders 810. Still, the second data may indicate assistance that the responder(s) 810 are to provide when arriving on scene, such as performing CPR, instructions for performing CPR, checking whether the user 700 is breathing, etc. The display 1204 of the responder device 806, in an embodiment, may display instructions (e.g., images, video, text, etc.) to assist the responder in providing the assistance. In an embodiment the second data may represent a phone call, SMS, email, or other form of communication to the responder device(s) 806. Upon receipt, the responder device(s) 806 may display the second data, or otherwise output the second data (e.g., audio). In an embodiment, the remote system 804 may send the second data in response to the emergency alert 920 not being cancelled. For example, the remote system 804 may receive an indication of the life-threatening event, but may withhold issuing the emergency alert to the responder(s) until the remote system 804 awaits to see if the life-threatening event is canceled. If the remote system 804 receives an indication within a predetermined amount of time that the emergency alert 920 may canceled, or that the user 700 is OK, the remote system 804 may refrain from issuing the emergency alert 920.

In an embodiment, the remote system 804 may also communicate with the safety device 100, for example, letting the user 700 know that the responder(s) 810 are on their way. The safety device 100 may output audio or otherwise indicate that the responder(s) 810 are in transit to the user 700.

At step 1614, the process 1600 may include establishing a chatroom for the one or more responder device(s). For example, the remote system 804 may establish a chatroom or communication channel in which the responder(s) 810 may communicate about the emergency alert (e.g., status, updates, etc.). In an embodiment, the responder(s) 810 may be invited into the chatroom and the responder(s) 810, the user 700, and others may communicate within the chatroom. The safety device 100, the user device 802, the responder device(s) 810, and other devices may have suitable application program interface(s) (APIs) for communicating with one another. The chatroom may include log showing those involved in responding to the emergency alert 920, where the user 700 is located, when the life-threatening event occurred, the actions leading up to the life-threatening event, and the like.

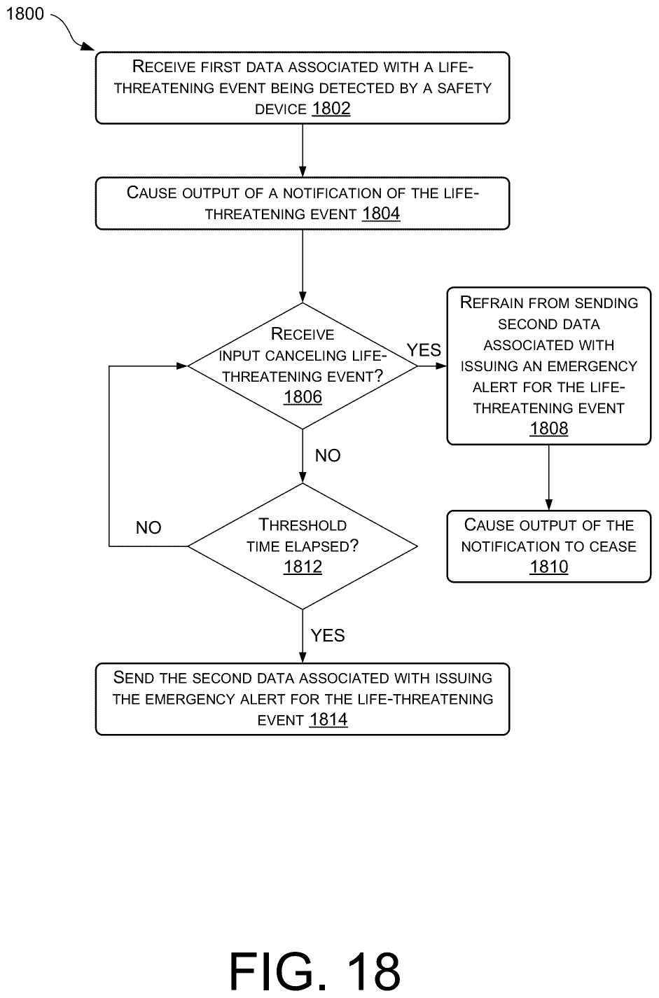

FIG. 17 illustrates an example process 1700 associated with the remote system 804 determining responders 810 for responding to the emergency alert 920.

At step 1702, the process 1700 may include receiving first data associated with an emergency alert. For example, the remote system 804 may receive first data associated with the safety device 100 detecting a life-threatening event (e.g., arc-flash, electrocution, fall, etc.). In an embodiment, the first data may include the time at which the life-threatening event was detected, an identifier of the user 700 (e.g., name), a location of the user 700, a type of life-threatening event detected, and/or other information associated with the life-threatening event. In an embodiment, the remote system 804 may receive the first data from the safety device 100 or the user device 802.

At step 1704, the process 1700 may include determining a first responder for responding to the emergency alert. For example, the remote system 804 may use the first data, the user profile(s) 1004, and/or the response profile(s) 1006 for determining the first responder. In an embodiment, the first responder is determined based on a proximity of the first responder to the user 700. For example, the remote system 804 may receive an indication of the location of the first responder (e.g., a device of the first responder) and compare the location to that of the user 700. In an embodiment, the first responder may be selected based on the first responder being located closest to the user 700. In another embodiment, the first responder may be determined based on an expertise of the first responder, the type of life-threatening event experienced, preferences of the user 700 (e.g., via the user profiles 1004), and the like.

At step 1706, the process 1700 may include sending second data associated with the emergency alert to a first responder device of the first responder. For example, the remote system 804 may transmit the emergency alert 920 to the first responder device that is associated with a request for traveling to the user 700 and providing assistance. In an embodiment, the second data sent to the first responder device may include the same data (or a portion thereof) received from the safety device 100 or the user device 802 (e.g., time, place, type of life-threatening event, etc.). The first responder device may display the emergency alert 920 and/or the information associated therewith. In an embodiment, the remote system 804 may transmit the emergency alert 920 to the first responder device based at least in part on a predetermined amount of time elapsing within receiving an indication to cancel the life-threatening event and/or issuing the emergency alert 920.

At step 1708, the process 1700 may include determining whether the first responder is responding. For example, the remote system 804 may track a location of the first responder device for determining whether the first responder is responding to the emergency alert 920. This may include determining whether the first responder will arrive at the user 700 within a certain amount of time. Additionally, rather than tracking the location of the first responder for determining whether the first responder is responding to the emergency alert 920, the remote system 804 may determine whether the first responder 810 has provided an indication (e.g., confirmation) that they will respond to the emergency alert 920. For example, upon receiving the second data, the first responder may confirm whether or not they will respond to the emergency alert 920. In an embodiment, even if the first responder confirms that they will respond, the remote system 804 may additionally track the location of the first responder to know whether or not the first responder is in fact responding and/or whether the first responder will arrive at the user 700 within a threshold amount of time. These determinations may ensure that someone is responding to the emergency alert 920 and providing assistance to the user 700.

If at step 1708 the process 1700 determines that the first responder is not responding, the process 1700 may follow the “NO” route and proceed to step 1710. At step 1710, the process 1700 may include determining a second responder for responding to the emergency alert. To determine the second responder, the remote system 804 may use the first data, the user profile(s) 1004, and/or the response profile(s) 1006. The second responder may also be determined based on a proximity to the user 700 (e.g., next closest responder as compared to the first responder).

At step 1712, the process 1700 may include sending third data associated with the emergency alert to a second responder device of the second responder. For example, the remote system 804 may transmit the emergency alert 920 to the second responder device that is associated with a request for traveling to the user 700 and providing assistance. The third data may be similar to the second data sent to the first responder device, and the second responder device may be configured to display the information to the second responder.

If at step 1708 the process 1700 determines that the first responder is responding, the process 1700 may follow the “YES” route and proceed to step 1714. At step 1714, the process 1700 may include refraining from determining one or more additional responder(s) for responding to the emergency alert 920. For example, being as the first responder is responding, the remote system 804 may not determine other responder(s) to respond to the user 700. However, in an embodiment, the remote system 804 may determine multiple users for responding to the emergency alert 920. In such embodiment, more than one responder 810 may be instructed to provide assistance to the user 700.

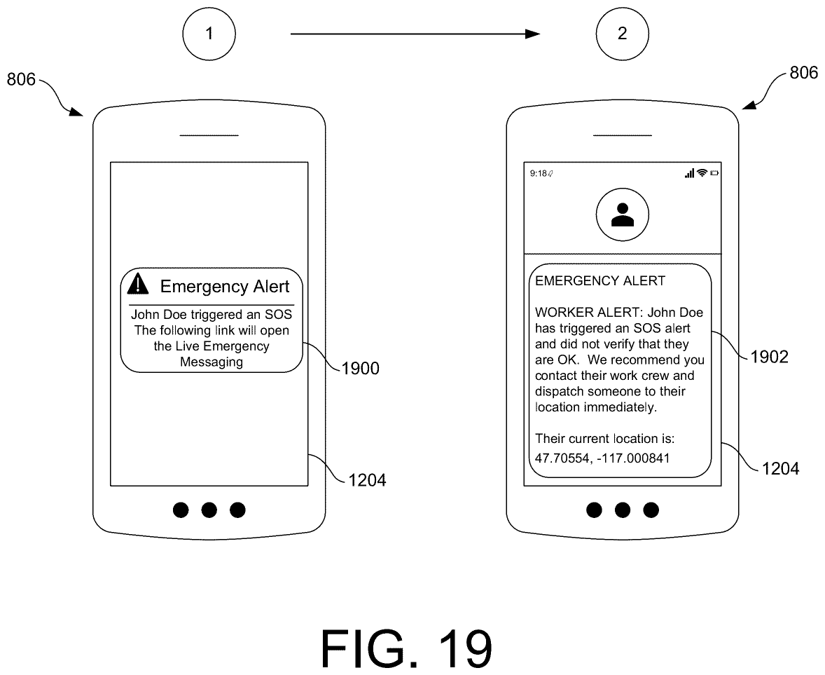

FIG. 18 illustrates an example process 1800 associated with the user device 802 acting as an intermediary between the safety device 100 and the remote system 804. For example, the safety device 100 may communicate with the user device 802, and likewise, the user device 802 may communicate with the remote system 804, vice versa.

At step 1802, the process 1800 may include receiving first data associated with a life-threatening event being detected by a safety device. For example, the user device 802 may receive first data that indicates the safety device 100 detecting a life-threatening event (e.g., arc-flash, electrocution, fall, etc.). In an embodiment, the user device 802 may receive the first data in response to the life-threatening event being detected, or may receive the first data and determining the occurrence of the life-threatening event. In an embodiment, the first data may include the time at which the life-threatening event was detected, an identifier of the user 700 (e.g., name), a location of the user 700, a type of life-threatening event detected, and/or other information associated with the life-threatening event. In an embodiment, the user device 802 may receive the first data via a first communication protocol (e.g., Bluetooth, BLE, etc.). Moreover, the first data may be received in response to the user 700 pressing a button the safety device 100 (e.g., S.O.S), providing a verbal command as captured by the microphone(s) 934, and so forth.

At step 1804, the process 1800 may include causing output of a notification associated with the life-threatening event. For example, responsive to receiving the first data, the user device 802 may present information on the display 1106 associated with the life-threatening event. The user device 802 may also output sound (e.g., alarm, siren, etc.) associated with the life-threatening event. Additionally, or alternatively, the user device 802 may also vibrate. The notification, whether visual, audible, haptic, or any combination thereof, may serve to get the attention of the user 700 as an attempt to either confirm or deny the life-threatening event.

At step 1806, the process 1800 may include determining whether input is received associated with cancelling the life-threatening event. For example, the user 700 may have mistakenly issued the life-threatening event (e.g., via pressing the second button 120), and may want to prevent the emergency alert 920 being issued. In another example, the safety device 100 may have improperly detected the life-threatening event and the user 700 may be OK (e.g., not in need of assistance). The user 700, for example, may have dropped the safety device 100. Here, the safety device 100 detected the life-threatening event, but the user 700 may not be in need of assistance.

In an embodiment, the input is received from the safety device 100. For example, the user 700 may press the second button 120 to provide an indication to cancel the life-threatening event. In such embodiment, the user device 802 may receive an indication of the button press and associate this press within cancelling the life-threatening event. Additionally, or alternatively, the user device 802 may also display an icon (e.g., button, indication, etc.) associated with cancelling the life-threatening event or issuing the emergency alert 920. For example, if the safety device 100 incorrectly detected the life-threatening event, or the user 700, the pressing the icon may cancel the life-threatening event as well as issuance of the emergency alert 920. In an embodiment, the user 700 may have to press the second button 120 or the icon the user device within a predetermined amount of time to cancel the life-threatening event. Thereafter, if no input is received, the user device 802 may be instructed or otherwise caused to transmit the emergency alert 920 to the remote system 804. In other embodiments, an indication of the life-threatening event may have been sent to the remote system 804, but the remote system 804 may refrain from issuing the emergency alert 920 to the responder(s) 810 if the input is received.

If at step 1806 the process 1800 determines that the input was received, the process 1800 may follow the “YES” route and proceed to step 1808. At step 1808, the process 1800 may include refraining from sending second data associated with issuing an emergency alert for the life-threatening event. For example, when the user 700 provides the input to cancel the life-threatening event, the user device 802 may refrain from issuing the emergency alert 920. This includes the user device 802 refraining from communicating with the remote system 804, the responder devices 806, and the like. As such, for example, because the life-threatening event may have been improperly detected, or the second button 120 may have been inadvertently pressed, the emergency alert 920 will not be sent. In other embodiments, the user device 802 may issue the emergency alert 920 to the remote system 804, but in response to receiving the input, the remote system 804 may not issue the emergency alert 920 to the responder(s) 810.

At step 1810, the process 1800 may include causing output of the notification to cease. For example, the user device 802 may stop displaying the life-threatening event on the display 1106, emitting sound via the speaker(s) 1104, or vibrating. Additionally, the safety device 100 may also stop output of the notification. In an embodiment, when the emergency alert 920 is cancelled, sensor data 906 or other information associated with the detection of the life-threatening event (whether inadvertent or real) may be sent to the remote system 804 for use, analysis, updating of the threshold(s), and so forth.

At step 1806, if the process 1800 determines that the input was not received, the process 1800 may follow the “NO” route and proceed to step 1812. At step 1812, the process 1800 may include determining whether a threshold amount of time has elapsed since receiving the first data associated with the life-threatening event. In an embodiment, the threshold amount of time may be any suitable amount of time by which the user 700 is provided the opportunity to cancel the emergency alert 920 (as discussed above). For example, the threshold period of time may be five seconds, ten seconds, 30 seconds, and the like. In other words, the user 700 is provided the threshold period of time to cancel issuance of the emergency alert 920.

In an embodiment, the threshold period of time may be based at least in part on the first data, such as the type of life-threatening event detected, the specifics of the life-threatening event (e.g., acceleration detected, amount of voltage detected, amount of current detected, etc.), the location of the user 700, and the like. Such information may be indicative of the severity of the life-threatening event, and as such the threshold period of time may be modified. Still, other examples, the user device 802 may automatically transmit the emergency alert 920 without waiting or providing the opportunity for the life-threatening event to be cancelled.

If at step 1812, the process 1800 determines that the threshold period of time has not elapsed, the process 1800 may follow the “NO” route and loop to step 1806. Here, the user device 802 may await input for the user 700 to cancel the life-threatening event and determine whether the threshold period of time has elapsed. Alternatively, if at step 1812 the process 1800 determines that the threshold period of time has elapsed, the process 1800 may follow the “YES” route and proceed to step 1814.

At step 1814, the process 1800 may include sending the second data associated with issuing the emergency alert for the life-threatening event. For example, if the user device 802 does not receive any input for cancelling the life-threatening event within the threshold period of time, the user device 802 may send the second data for issuing the emergency alert 920. In response, the remote system 804 may coordinate a response for responding to the life-threatening event. In an embodiment, the second data that is sent to the remote system 804 may include the first data (received at step 1802), or at least a portion of the first data. The user device 802 may communicate with the remote system 804 via a second communication protocol (e.g., cellular).

Although the process 1800 is described as providing an opportunity for the user 700 to cancel the life-threatening event, in an embodiment, the process 1800 may additionally or alternatively provide an opportunity for the user 700 to confirm the life-threatening event. For example, the user 700 may confirm (prior to the threshold period of time elapsing) that they are in need of assistance and to issue the emergency alert 920. This may cause the emergency alert 920 to be issued quicker. In an embodiment, the safety device 100 and the user device 802 may provide the opportunity to both cancel and confirm the life-threatening event.

Still, although the process 1800 is described as the life-threatening event being routed through the user device 802, the safety device 100 may communicate directly with the remote system 804. As such, the user device 802 does not need to act as an intermediary between the safety device and the remote system 804 (or other devices).

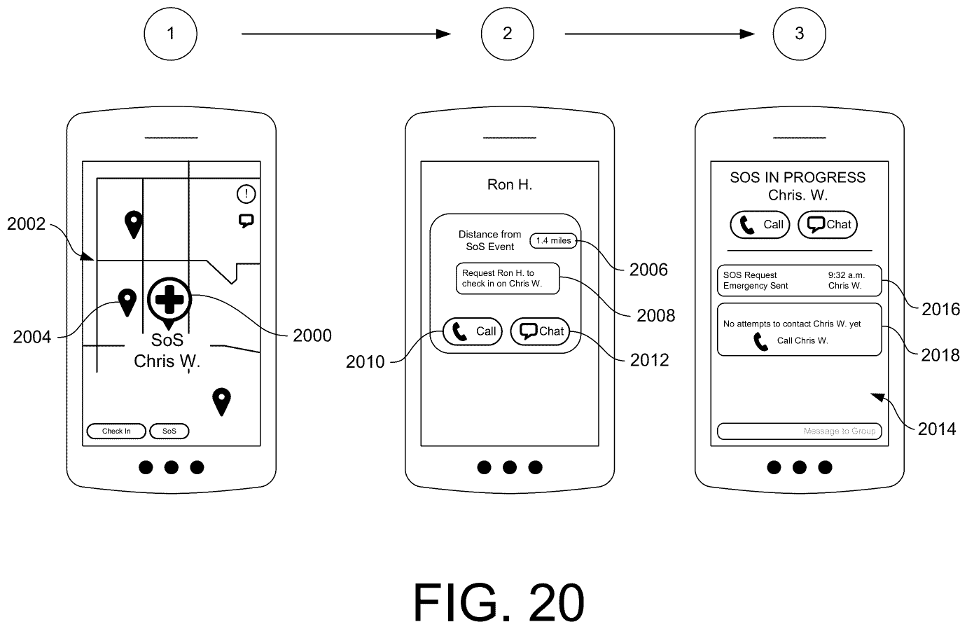

FIGS. 19-22 illustrate various figures that are associated with presenting user interface(s) (UI) on various devices associated with the detection of the emergency alert 920. For example, the user device 802, the responder device 806, the remote system 804, and/or dispatch device 814 may include respective application program interface(s) APIs that present the UIs. The APIs respectively allow the user device 802, the responder device 806, the remote system 804, and/or dispatch device 814 to communicate with one another about the emergency alert 920, responding to the emergency alert 920, and so forth.

In an embodiment, the application can be a mobile application, a web application, or a desktop application, which can be provided by the communication platform or which can be an otherwise dedicated application. In some examples, individual user computing devices can have an instance or versioned instance of the application, which can be downloaded from an application store, accessible via the Internet, or otherwise executable by processor(s) of the user device 802, the responder device 806, the remote system 804, and/or dispatch device 814 to perform operations as described herein. That is, the application can be an access point, enabling the user device 802, the responder device 806, the remote system 804, and/or dispatch device 814 to interact. In at least one example, the application can facilitate the exchange of data between and among various other user computing devices. In at least one example, a user can interact with the UIs via touch input, keyboard input, mouse input, spoken input, or any other type of input. In some examples, the user device 802, the responder device 806, the remote system 804, and/or dispatch device 814 can facilitate communication via Websockets, APIs (e.g., using API calls), HTTPs, etc.

FIG. 19 illustrates a series of user interfaces or displays associated with an emergency alert 920 being issued for a user 700. For example, in response to the safety device 100 issuing the emergency alert 920, the remote system 804 may contact the responder device 806 associated with the responder 810. In an embodiment, the remote system 804 may automatically contact the responder(s) 810, or the dispatcher 812 (using the dispatch device 814) may contact the responder(s) 810.

As noted above, the responder 810 may be selected based on the user profile 1004 associated with the user 700, the response profile 1006, a geographical proximity of the responder 810 to the user 700, or other criteria. In an embodiment, the responder 810 may be part of a response team previously indicated to respond to the emergency alerts 920 associated with the user. Additionally, the responder 810 need not be the only person contacted, but other responders may be contacted simultaneously or after the responder 810 has been contact.

At “1,” the display 1204 of the responder device 806 may present an icon 1900 associated with the emergency alert 920. In an embodiment, the icon 1900 is presented on a lock or home screen of the responder device 806. In an embodiment, the icon 1900 may indicate that the emergency alert 920 has been issued by the user 700, and/or present prompts to the responder 810 for responding to the emergency alert 920. The responder device 806 may also output audio (e.g., siren, alarm, etc.), vibrate, or illuminate (e.g., flash) to indicate the emergency alert 920 being issued. Such outputs may garner the attention of the responder 810 and indicate the severity of the emergency alert 920.

At “2,” the display 1204 of the responder device 806 may display information 1902 associated with the emergency alert 920. For example, the responder 810 may click on the icon 1900 at “1,” and in turn, the responder device 806 may display the information 1902 of the emergency alert 920 at “2.” In an embodiment, the information 1902 may include additional details of the user 700 or the emergency alert 920, such as whether the user 700 has since indicated that they are OK (e.g., via pressing the second button 120), a last known location of the user 700, a time at which the emergency alert 920 was triggered, and/or recommendations for responding to the emergency alert 920. Other information may additionally or alternatively be displayed.

In an embodiment, the dispatcher 812 of the remote system 804 may provide the icon 1900 and/or the information 1902 to the responder 810. For example, the dispatcher 812 may contact the responder 810, and engage in a communication with the responder 810 via a chatroom, text string, and the like.

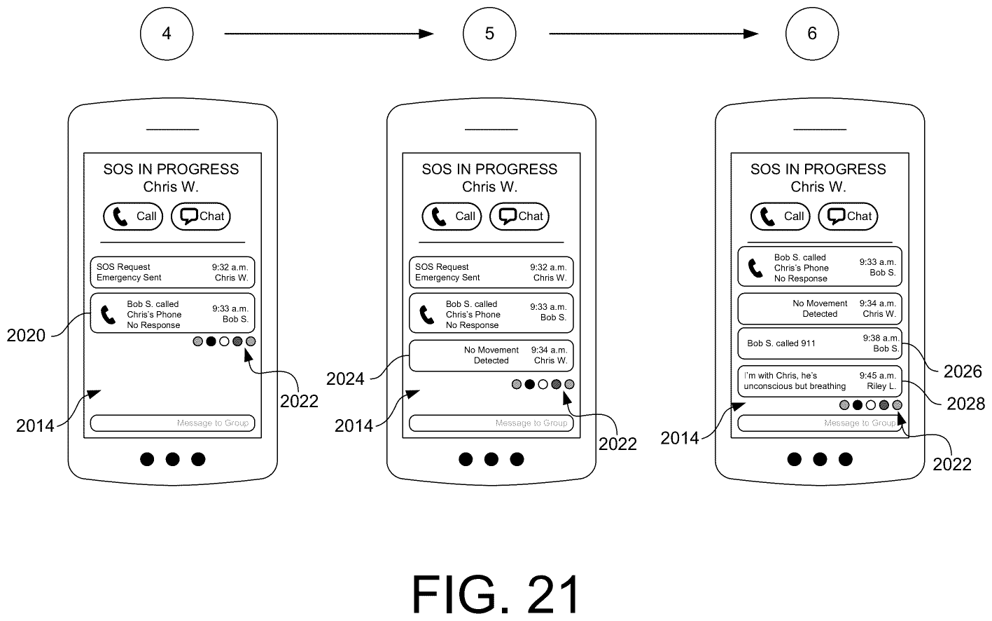

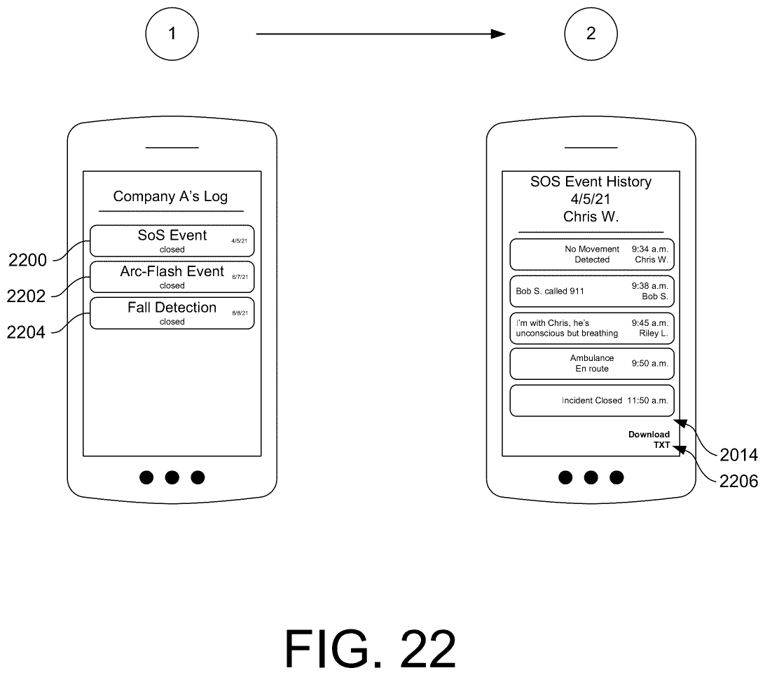

FIGS. 20 and 21 illustrates a series of user interfaces or displays associated with an emergency alert 920 being issued for a user 700. In an embodiment, the series of user interfaces may be presented on the dispatch device 814 of the dispatcher 812. As discussed above, in an embodiment, the dispatcher 812 may assist in organizing, overseeing, or coordinating a response to the emergency alert 920.

At “1,” an emergency alert 920 is shown being issued for a user 700. In an embodiment, the emergency alert 920 may be displayed as a first icon 2000 within a map 2002 presented on the display 1204 of the dispatch device 814 or the responder device 806. Additionally, second icons 2004 are shown being displayed for other users 700. For example, the locations of the other users 700 (who may also be responders 810), may be known from location sensors onboard their safety devices 100, respectively, or other device(s) (e.g., phones, tablets, work vehicles, etc.). Displaying the first icon 2000 in conjunction with the second icons 2004 visually illustrates the relative locations of the user 700 associated with the emergency alert 920 as well as potential responders 810. This may be useful for the dispatcher 812 to select or identify those responders 810 for dispatching to respond to the emergency alert 920. The first icon 2000 may be displayed differently than the second icons 2004 (e.g., size, color, symbols, etc.) to highlight or otherwise signify the emergency alert 920. Moreover, the display of the first icon 2000 in relation to the second icons 2004 may indicate, to the responders 810, their relative location to the other responders 810.

In an embodiment, the dispatcher 812 may toggle, scroll, or otherwise pan through the map 2002 for viewing additional users 700 and/or emergency alerts 920. Here, the display of the dispatch device 814 may update as the map 2002 displays new areas, environments, and the like. For example, if the map 2002 moves to a new location (or zooms out), other emergency alerts 920 may be displayed. For example, other emergency alert 920 may have been issued for another area within the map 2002.

At “2,” the dispatcher 812 may select one of the second icons 2004 for viewing information associated with another of the users 700. For example, clicking on one of the second icons 2004 (e.g., closest in proximity to the emergency alert 920), may yield information about the other users 700. For example, at “2,” the display of the dispatch device 814 may indicate a distance 2006 between the other user 700 and the user 700 associated with the emergency alert 920. The dispatcher 812 may also have the ability to request that the other users 700 respond to the emergency alert 920. For example, selecting a third icon 2008 may issue a request to the other user 700 to respond to the emergency alert 920. Additionally, the dispatcher 812 may have the ability to call 2010 or text 2012 the other user 700. For example, the dispatcher 812 may communicate with the other users 700 to understand whether they have the ability, capacity, training, and the like to respond to the emergency alert 920. The dispatcher 812 may also select other second icons 2004 for determining similar information about the other users 700.

At “3,” the dispatcher 812 may select the first icon 2000 to open a chatroom 2014 (e.g., text string, dialogue window, communication channel, etc.) for responding to the emergency alert 920. The dispatch device 814 is shown displaying information associated with the emergency alert 920, options to call or text the user 700, or other information associated with the emergency alert 920 (e.g., time, type, etc.). For example, within the chatroom 2014, the display is shown displaying a first indication 2016 of when the emergency alert 920 was issued and who the emergency alert 920 is associated with. The first indication 2016 may also display information of the type of emergency alert 920 (e.g., whether the life-threatening event was automatically detected by the safety device 100, whether the user 700 pressed the second button 120 to issue the emergency alert 920, etc.). Further, a second indication 2018 is displayed that indicates whether anyone has attempted to contact the user 700. For example, as shown, the second indication 2018 indicates that no attempts have been made to contact the user 700.

At “4,” which is shown on FIG. 21 and which may continue from “3” in FIG. 20, the chatroom 2014 may be updated with a third indication 2020 that one of the responders 810 attempted to contact the user 700. As shown, the third indication 2020 may include an identity of the responder 810 (i.e., the responder 810 who posted the third indication 2020), the time associated with the responder 810 attempting to contact the user 700, and/or whether the user 700 responded to the inquiry. As also shown at “4,” the chatroom 2014 may indicate the responders 810 that have viewed the third indication 2020. For example, an indicia 2022 of each of the responders 810 may be vertically below the third indication 2020, and indicate whether the responders 810 have seen the third indication 2020.

In this manner, the chatroom 2014 may serve to centralize communications between the user 700, the responders 810, and/or the dispatcher 812 when responding to the emergency alert 920. Each of the responders 810 may communicate within the chatroom 2014 via respective responder devices 806. In an embodiment, the responders 810 may be invited to join the chatroom 2014 in response to being selected as the responder(s) 810. In addition, personnel associated with the user 700, such as their manager, spouse, friend, etc., or other people indicated in their user profile 932/1004 and/or response profile 1006 may be invited to join the chatroom 2014. By displaying the third indication 2020, as well as up to date information of the emergency alert 920, the other responders 810 may see that one of the responders 810 has attempted to contact the user 700, but that no response was given. This may avoid a scenario where all the responders 810 are attempting to contact the user 700 at the same time or performing redundant actions when responding to the emergency alert 920. Further, within the chatroom 2014, the responders 810 may inform one another of steps or actions taken to respond to the user 700. As such, this may centralize the communications to avoid duplicative, redundant, or unnecessary actions, and informs the responders 810 of the most-recent information concerning the emergency alert 920. Additionally, the user 700 themselves may be included in the chatroom 2014. For example, using the user device 802, the user 700 may communicate with the responders 810 and/or the dispatcher 812 in the chatroom 2014.

In an embodiment, those responders 810 that are invited or included within the chatroom 2014 are determined from the user profile 1004 and/or the response profile 1006. For example, the remote system 804 may determine the responders 810 for responding or alerting of the emergency alert 920, and in response, may establish the chatroom 2014 within which the responders 810 may communicate. In an embodiment, however, one or more of the responders 810 invited into the chatroom 2014 may be dispatched to travel to the user 700.

At “5,” the chatroom 2014 may be updated with a fourth indication 2024 that no movement was sensed from the safety device 100. For example, after sending of the emergency alert 920, the safety device 100 may continue to monitor sensed conditions associated with the user 700. This may include, for example, whether the user 700 has moved (e.g., via the accelerometer 916), whether audio of the user 700 was detected (e.g., via the microphone(s) 934), whether the user 700 pressed buttons on the safety device 100, whether the user 700 attempted to call or ask for help, etc. Such updates may be received from the safety device 100 or the user device 802. The updates may be used by the responders 810 to understand the status of the user 700. The indicia 2022 further shows which responders 810 have seen the fourth indication 2024.

At “6,” the chatroom 2014 is shown being updated with a fifth indication 2026 and a sixth indication 2028. The fifth indication 2026 indicates that 911 (or other emergency services) have been called. For example, the fifth indication 2026 may indicate which of the responders 810 initiated calling 911. As noted above, the chatroom 2014 serves to centralize the communications for the emergency alert 920, as well as avoid duplicative actions. For example, when one responder calls 911, and the chatroom 2014 is updated with the fifth indication 2026 to indicate such, the other responders 810 may refrain from calling 911. This efficiently utilizes resources and avoids unnecessary calls being made to 911, for example.

The sixth indication 2028 indicates a response from one of the responders 810. For example, one the responders 810 may travel to the user 700 and indicate a current state of the user 700. The responder 810 may provide the sixth indication 2028 to inform the rest of the responders 810 (or the dispatcher 812), as to the health, wellness, or status of the user 700. This may serve as a notification that one of the responders 810 has arrived on scene and/or is with the user 700. This may avoid conflicts on dispatching other responders 810 to the user 700. The indicia 2022 is also provided to indicate which of the responders 810 has viewed the sixth indication 2028.

The communications within the chatroom 2014 are tracked, stored, or otherwise recorded by the remote system 804. For example, the remote system 804 may record the communications within the chatroom 2014 in the emergency alert database 1014. The emergency alerts 920 are cataloged within the emergency alert database 1014 for training purposes, as well to create a log that indicates the actions, timing, and occurrence of events after the emergency alert 920 was issued. This may be used to update future response profiles 1006, or response procedures when responding to the emergency alerts 920.

Further, the chatroom 2014 communications, or the chatroom 2014 itself, is just one example and it is understood that the chatroom 2014 may look differently than represented. Additionally, the chatroom 2014 may include other indications that those illustrated. As an example, the chatroom 2014 may include more or less information than shown, or may include pictures, videos, gifs, maps, etc. Regardless, the communications between the responders 810, the user 700, the dispatcher 812, or other personnel, may be recorded and stored for later uses.

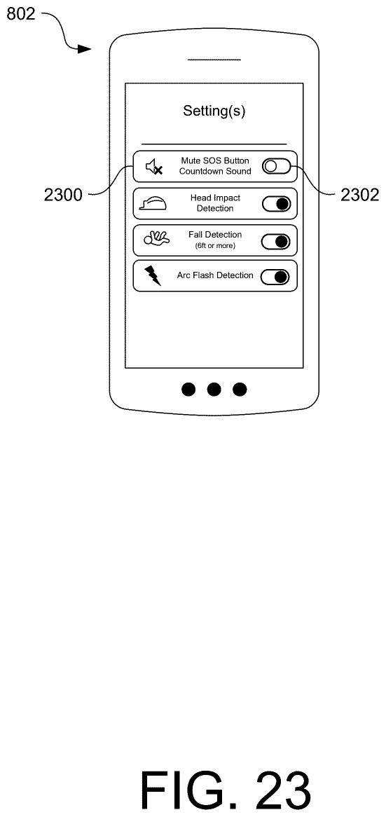

FIG. 22 illustrates a series of user interfaces or displays associated with accessing information from the emergency alert database 1014. In an embodiment, the series of user interfaces may be presented on the dispatch device 814, the responder device 806, the user device 802, or other devices (e.g., a supervisor or manager of a company).

As shown at “1,” a device (e.g., user device 802, responder device 806, etc.) may display information associated with the emergency alerts 920. In an embodiment, the emergency alerts 920 are accessed, or obtained, via the emergency alert database 1014 stored on the remote system 804. For example, the device may receive data from the remote system 804 associated with the emergency alerts 920, and in response, may display the emergency alerts 920.

The emergency alerts 920 displayed may be associated with a particular company of the users 700, for a particular user 700 of the company, and the like. This may allow personnel to view and/or manage the emergency alerts 920. Such emergency alerts 920 may be presented in response to a query for information about the emergency alerts 920. For example, at “1” the device may display a first indication 2200 of a first emergency alert, a second indication 2202 of a second emergency alert, and a third indication 2204 of a third emergency alert. The first indication 2200, the second indication 2202, and/or the third indication 2204 may display information associated with the emergency alerts 920, respectively, such as the type of emergency alert 920 (e.g., fall, arc-flash, S.O.S., etc.), a date and/or time at which the emergency alert 920 occurred, a user involved in the emergency alert 920, whether the emergency alert 920 is/are still pending or have been resolved, etc. Although three emergency alerts 920 are shown, the device may display other emergency alerts, and an operator of the device may scroll through the emergency alerts, filter the emergency alerts 920 based on type, time, location, etc. The emergency alerts 920 may also be displayed in formats other than those shown (e.g., grid-like fashion, side-by-side, table, etc.).

At “2,” the device may display additional information associated with a selected indication, such as the first indication 2200. For example, an operator of the device at “1” may select the first indication 2200, and in response, information of the emergency alert 920 associated with the first indication 2200 may be displayed at “2.” Here, as shown, the information that is displayed may include communications that took place between responders 810 within a chatroom 2014. The chatroom 2014 may also indicate actions undertaken in responding to the emergency alert 920, such as when 911 was called and/or when an ambulance was requested. This data may be received via accessing the emergency alert database 1014. Additionally, the data may be downloadable, for example, by selecting a download icon 2206.

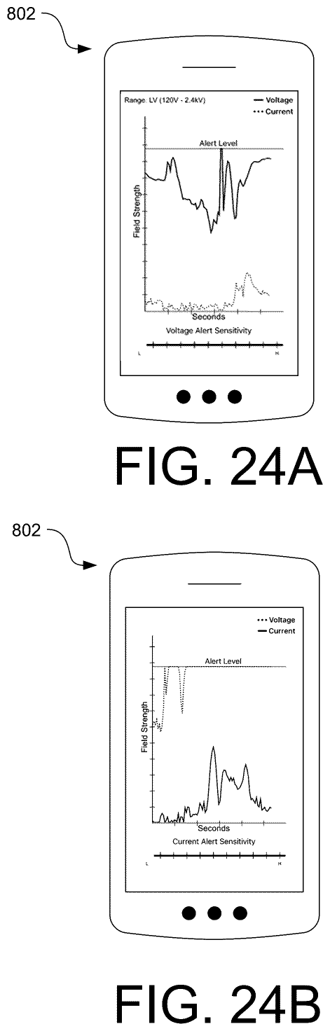

FIG. 23 illustrates a user interface associated with determining or configuring setting(s) of the safety device 100. For example, using the user device 802, the user 700 may determining the types of life-threatening events that the safety device 100 is to monitor for, or otherwise respond to. By way of example, the user device 802 may display an indication 2300 associated with head impacts, fall detection, arc-flashes, and so forth. For each of these life-threatening events, the user 700 may use a toggle 2302 to either configure the safety device 100 to monitor for these life-threatening events using the sensor data 906. Additionally, an indication and/or toggle may be included for muting the countdown for issuing the emergency alert 920.

To configure the safety device 100 according to the determined setting(s), the user device 802 may transmit the setting(s) to the safety device 100 (e.g., via Wi-Fi, Bluetooth, etc.). In an embodiment, the safety device 100 may be brought into a certain proximity of the user device 802 to configure the safety device 100 according to the setting(s).

Although certain indications and/or toggles are shown, other indications and/or toggles may be included (e.g., shock). Further the user 700 may have the ability to adjust the settings or sensitivities when determining the life-threatening events. For example, the user 700 may adjust a threshold amount of acceleration, or change in acceleration, when issuing an emergency alert 920 for fall detection, and/or the intensity of the light when detecting arc-flashes.

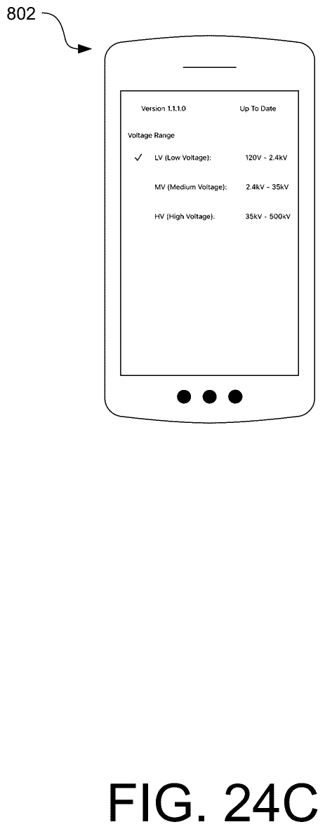

FIGS. 24A-24C illustrate a user of the user device 802 to configure setting(s) of the safety device 100. For example, in FIG. 24A, the user 700 may adjust a sensitivity of the safety device 100 for voltage detection and issuing emergency alerts 920. By way of example, the user 700 may adjust the threshold at which a detected voltage must exceed in order for the emergency alerts 920 to be issued. In an embodiment, the user device 802 may also display the detected field strength of the voltage, for use in aiding the user 700 in setting the threshold.

For example, in FIG. 24B, the user 700 may adjust a sensitivity of the safety device 100 for current detection and issuing emergency alerts 920. By way of example, the user 700 may adjust the threshold at which a detected current must exceed in order for the emergency alerts 920 to be issued. In an embodiment, the user device 802 may also display the detected field strength of the current, for use in aiding the user 700 in setting the threshold.

In FIG. 24C, the user 700 may indicate detected voltage ranges of the safety device 100. In an embodiment, the setting(s), once set by the user 700, may be provided to the safety device 100 such that the safety device 100 is able to monitor for life-threatening event(s) using the setting(s) established by the user 700.

Although the user interfaces are shown including certain functionalities and/or capabilities, the user 700 may interact with the user device 802, for example, to adjust other setting(s) of the safety device 100, detecting and responding to the life-threatening events, and/or otherwise controlling or viewing a status of the safety device 100. For example, via the user interfaces, the user 700 may view a battery life of the safety device 100, may be able to locate their safety device 100 (e.g., find my safety device 100, which outputs an audible of visual indication on safety device 100), may change their emergency contacts, change the notification(s) 910 (e.g., color, sound, intensity, etc.), and so forth.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A device comprising:
a housing;
one or more lighting elements at least partially disposed within the housing;
an ultraviolet (UV) sensor at least partially disposed within the housing:
one or more processors; and
one or more computer-readable media storing instructions that, when executed, cause the one or more processors to perform operations including:
receiving sensor data from the UV sensor,
determining, based at least in part on the sensor data, an intensity of light,
determining a threshold associated with the UV sensor,
determining that the intensity of light satisfies the threshold, and
causing, based at least in part on the intensity of light satisfying the threshold, the one or more lighting elements to emit light.

2. The device of claim 1, further comprising at least one of a light pipe or a lens that directs light to the UV sensor.

3. The device of claim 1, further comprising one or more network interfaces, the operations further including sending, via the one or more network interfaces, data associated with the intensity of light to an additional device.

4. The device of claim 1, further comprising one or more buttons, wherein:
the one or more buttons are disposed on a first side of the housing; and
the UV sensor is disposed on a second side of the housing.

5. The device of claim 1, further comprising one or more attachment mechanisms for securing the device to at least one of a hardhat or a clothing of a user.

6. The device of claim 1, wherein the UV sensor is configured to detect light with a wavelength between 300 and 400 nanometers.

7. The device of claim 1, further comprising at least one of:
a voltage detector at least partially disposed within the housing; or
a current detector at least partially disposed within the housing.

8. A device comprising:
a housing;
one or more attachment mechanisms for securing the device to a hardhat;
an ultraviolet (UV) sensor at least partially disposed within the housing, the UV sensor configured to detect arc-flashes within an environment of the device;
one or more buttons at least partially disposed within the housing; and
one or more lighting elements at least partially disposed within the housing, the one or more lighting elements configured to output light based at least in part on the UV sensor detecting arc-flashes within the environment.

9. The device of claim 8, further comprising at least one of:
a voltage detector at least partially disposed within the housing; or
a current detector at least partially disposed within the housing.

10. The device of claim 8, wherein:
the housing includes:
a first side, and
a second side;
the UV sensor is located on the first side; and
the one or more lighting elements and the one or more buttons are located on the second side.

11. The device of claim 10, wherein:
the housing includes a third side opposite the second side; and
the one or more attachment mechanisms are at least partially located on the third side.

12. The device of claim 8, further comprising a speaker configured to output sound based at least in part on the UV sensor detecting arc-flashes within the environment.

13. The device of claim 8, wherein the UV sensor is configured to detect light having a wavelength between 300 and 400 nanometers.

14. The device of claim 8, further comprising one or more network interfaces that communicatively connect the device to one or more additional devices.

15. A method comprising:
receiving sensor data associated with detected light;
determining, based at least in part on the sensor data, a brightness value associated with the detected light;
determining a threshold associated with issuing a notification;
determining that the brightness value satisfies the threshold;
causing, based at least in part on the brightness value satisfying the threshold, output of the notification; and
sending data associated with the detected light.

16. The method of claim 15, wherein the notification comprises at least one of light or sound.

17. The method of claim 15, wherein the detected light comprises UV light having a wavelength between 300 and 400 nanometers.

18. The method of claim 15, further comprising:
receiving second sensor data associated with at least one of a voltage or a current;
determining a second threshold associated with issuing the notification; and
determining that the at least one of the voltage or the current satisfies the second threshold,
wherein causing output of the notification is based at least in part on the at least one of the voltage or the current satisfying the second threshold.

19. The method of claim 15, wherein:
the notification is output on a first device; and
the data is sent to a second device communicatively connected to the first device.

20. The method of claim 15, further comprising determining, based at least in part on the brightness value, a proximity to a light source that emitted the detected light, and wherein causing output of the notification is based at least in part on the proximity.
